(19) United States
(12) Patent Application Publication
(10) Pub. No.: US 2020/0160411 A1
(43) Pub. Date: May 21, 2020

(54) Methods and Systems for Optimal Joint Bidding and Pricing of Load Serving Entity

(71) Applicant: Mitsubishi Electric Research Laboratories, Inc., Cambridge, MA (US)

(72) Inventors: Hongbo Sun, Lexington, MA (US); Hanchen Xu, Urbana, IL (US)

(73) Assignee: Mitsubishi Electric Research Laboratories, Inc., Cambridge, MA (US)

(21) Appl. No.: 16/193,058

(22) Filed: Nov. 16, 2018

(51) Int. Cl. G06Q 30/02; G06Q 30/04; G06Q 30/08; G06Q 50/06

(52) U.S. Cl. CPC G06Q 30/0283; G06Q 50/06; G06Q 30/08; G06Q 30/04

(57) ABSTRACT

Systems and methods for controlling an operation of an electrical device in a market-based resource allocation system. The system having a processor to compute, an offer amount representative of a value at which electricity available to be supplied to operate an electrical device for an upcoming time interval at a user selected desired operating level. Transmit the offer amount to a local resource allocation market (LRAM). Receive back a cleared price for electricity from the LRAM. Compute, a retail price of electricity for operating the electrical device based at least in part on the user selected desired operating level, current environmental data, the cleared price for electricity and stored historical data, to obtain the retail price. Compare the submitted offer amount to the retail price. Activate or deactivate the electrical device based on the comparison.

### FIELD

The present disclosure relates generally to electric power systems, and more particularly to optimal joint bidding and pricing of load serving entity.

### BACKGROUND

Conventional power system restructuring has been going on for many years, which aims to improve power system planning and operation activities. On the transmission level, under a market-based regime, planning short-term and long-term electricity production and consumption activities, different parties from the supply side to the demand side, participate in a wholesale electricity market (WEM) which is operated by an independent system operator (ISO) to offer or bid for the electricity/energy.

Traditionally, sellers (or power producers) submit sealed offers and buyers (or power consumers) submit sealed bids to the ISO, which the ISO then clears the market and determines the cleared energy prices and cleared energy quantities for all participants. However, with the advancement of Smart Grid technologies, the advances bring real-time bidding & selling for 5- to 15-minute time intervals in the WEM that is operated by the ISO. The traditional role of a load serving entity (LSE) as a buyer in the WEM is to pass on the cleared energy prices and cleared energy quantities plus an added cost of a government tariff back to end use consumers (EUCs). Now, with real-time bidding & selling, the LSE is able to use a flexible price signal through a variety of demand response programs in the retail electricity market (REM) to interact with the EUCs, such that their behaviors are changed in way that benefits the LSE. As a consequence, under such an environment, a profit-seeking LSE is faced with two problems, i.e., the bidding problem that determines the optimal electricity bid it submits in the WEM, and the pricing problem that determines the optimal electricity price it charges the EUCs.

In application US 2005/0004858 A1, methods are disclosed for assisting a large industrial or business consumer of energy to become a self-serving retail electricity provider in a deregulated energy market. Performed by an energy advisory and transaction management service provider, one method registers the large business energy consumer with the state public utility commission, assists the business to qualify as a scheduling entity with an independent service operator, and establishes the business as a bilateral trading partner of wholesale energy merchants.

US 2014/0316973 A1 discloses an approach for facilitating the generation of energy-related revenue for an energy customer of an electricity supplier. The approach is used to generate operating schedules for a controller of the energy assets. When implemented, the generated operating schedules facilitates derivation of the energy-related revenue, over a time period T, associated with operation of the energy assets according to the generated operating schedule. The energy-related revenue available to the energy customer over the time period T is based at least in part on a wholesale electricity market.

However, all of these conventional approaches address the bidding problem and the pricing problem separately. Unfortunately, these conventional approaches ignore the strong coupling or relationship between the two problems, i.e. bidding and pricing, since the energy purchased in the WEM, and that sold in the REM, must balance, otherwise the LSE will incur economic losses or even reliability issues. Reliability issues relating to not having any energy to sell to their EUCs, if the LSE cannot make bids to the ISO that are competitive against other LSE's when buying the energy. Therefore, there is a need for new approaches that include a joint determination of the energy bid to be submitted in the WEM, and an energy price charged in the REM for an LSE, at least for the purpose of maximizing the LSE's total profit, among other reasons.

### SUMMARY

The present disclosure relates to electric power systems, and more particularly to optimal joint bidding and pricing of load serving entity.

In a restructured conventional electric power industry, a load serving entity (LSE) needs to submit bids for electricity/energy in a wholesale electricity market (WEM), which is operated by an independent system operator (ISO), so as to meet the demand from its end use customers (EUCs). The LSE then charges the EUCs for electricity/energy a conventionally fixed tariff that is regulated by the government. Therefore, the conventional decision-making process of the LSE involves only the bidding problem, i.e. the determination of the energy bids, which relies on the forecast of EUC demand, which is relatively inflexible.

However, due to the rapid development of smart grid technologies, demand-side management, becomes feasible through demand response programs such as real-time pricing. An LSE may determine a real-time energy price in the retail electricity market (REM) that the LSE operates to incentivize the EUCs changing their energy consumption behaviors in a way that benefits the LSE. In this context, in addition to the bidding problem, the LSE is also faced with the pricing problem—the determination of the energy price that is charged to the EUCs.

Conventional decision-making processes for LSE's involves only addressing the bidding problem, i.e. the determination of the energy bids, which rely on the forecast of EUC demands, which is relatively inflexible, as noted above. Thus, these conventional approaches are concerned with only one problem. Yet, there two problems are inherently coupled, since the energy purchased in the WEM and that sold in the REM must balance, and the profit earned by the LSE is dependent on the results in both markets. Therefore, the embodiments of the present disclosure solve the bidding problem as well as the pricing problem jointly.

During experimentation, one approach included modeling the joint bidding and pricing problem as a bi-level programming problem, which was solved using mixed integer linear programming techniques. However, these particular experimented approaches assume that all market participants are myopic or nearsighted, the parameters of all the experimented models, including all market participants in the WEM and all EUCs in the REM, are completely known to the LSE. More importantly, all the models are linear. These assumptions, however, are very constraining and impractical, in view of the aspects of the present disclosure.

Some embodiments of the present disclosure formulate the joint bidding and pricing problem as a Markov decision process (MDP), in which the energy bid and the energy price are two actions that shared as a common objective. In order to solve this MDP without the necessity to knowing the WEM and EUC models, a deep deterministic policy gradient based reinforcement learning algorithm can be devised to learn the bidding and pricing policies. The proposed reinforcement learning algorithm takes advantage of the decision-making process by determining the second stage action, e.g., the retail energy price, using information revealed after the first stage action, e.g., the energy bid, is taken, which improves the overall profit earned by the load serving entity, among other benefits.

Assuming the models of other market participants in the WEM and all EUCs in the REM are not known in advance. To this end, neural networks can be applied to learn a bid response function and a price response function from historical data to model the WEM, and the collective behavior of the EUCs respectively, from the perspective of the LSE. These response functions can explicitly capture the inter-temporal correlations of the WEM clearing results and the EUC demand, according to embodiments of the present disclosure.

Overall, aspects of the present disclosure provide a new model-free and flexible solution to the joint bidding and pricing problem. Some novelties of the present disclosure, among many novelties, include: a formulation of the joint bidding and pricing problem as an MDP, which allows the consideration of an accumulative profit of the LSE in the long-term; a development of a reinforcement learning algorithm that solves the MDP while taking into account its structural characteristics; using the application of the multi-layer feedforward neural networks (FNNs), recurrent neural networks (RNNs), or long short-term memory (LSTM) unit networks to model the WEM and the REM using historical data, which captures the inter-temporal correlations, among other novelties.

According to an embodiment of the present disclosure, a system to control operation of an electrical device in a market-based resource allocation system. The system having a processor configured, in as close to real-time, to receive, via a transceiver, a user selected desired operating level of an electrical device by a user for an upcoming time interval, the processor connected to a memory having executable programs and stored data. The system includes using the processor to compute, an offer amount representative of a value at which electricity is available to be supplied to operate the electrical device for the upcoming time interval at the user selected desired operating level. Wherein computing the offer amount is based on multiple factors for the upcoming time interval, including the user selected desired operating level, current environmental data, and stored historical energy futures market data used to determine inter-temporal correlation behaviors of past offer amounts to a local resource allocation market (LRAM) and past clearing pricing for electricity by the LRAM, to obtain the offer amount. Transmit, via the transceiver, the offer amount to the LRAM. Receive, via the transceiver, a cleared price for electricity from the LRAM from which the electrical device receives electricity. Compute, a retail price of electricity for operating the electrical device based at least in part on the user selected desired operating level, and the current environmental data, the cleared price for electricity from the LRAM and the stored historical data from the energy futures market used to determine inter-temporal correlation behaviors of past user selected desired operating levels by the user, past pricing for electricity in a retail electricity market (REM) and the past clearing pricing for electricity by the LRAM, to obtain the retail price. Wherein the computation of the offer amount and the retail price are computed jointly. Compare the submitted offer amount to the retail price. Activate or deactivate the electrical device based on the comparison.

According to another embodiment of the present disclosure, a system to control operation of an electrical device in a market-based resource allocation system. The system having a processor configured, in as close to real-time, to receive, via an input interface, a user selected desired operating level of an electrical device by a user for an upcoming time interval, the processor connected to a memory having executable programs and stored data. The system includes using the processor to compute, an offer amount representative of a value at which electricity is available to be supplied to operate the electrical device for the upcoming time interval at the user selected desired operating level. Transmit, via an output interface, the offer amount to a local resource allocation market (LRAM). Receive, via the input interface, a cleared price for electricity from the LRAM from which the electrical device receives electricity. Compute, a retail price of electricity for operating the electrical device based at least in part on the user selected desired operating level, and current environmental data, the cleared price for electricity from the LRAM and stored historical data from the energy futures market used to determine inter-temporal correlation behaviors of past user selected desired operating levels by the user, past pricing for electricity in a retail electricity market (REM) and past clearing pricing for electricity by the LRAM, to obtain the retail price. Wherein the computation of the offer amount and the retail price are computed jointly. Compare the submitted offer amount to the retail price. Activate or deactivate the electrical device based on the comparison.

According to another embodiment of the present disclosure, a method to control operation of an electrical device in a market-based resource allocation system. The method having a processor configured, in as close to real-time, to receive, via an input interface, a user selected desired operating level of an electrical device by a user for an upcoming time interval. The processor connected to a memory having executable programs and stored data. The method includes using the processor for computing, an offer amount representative of a value at which electricity is available to be supplied to operate the electrical device for the upcoming time interval at the user selected desired operating level. Transmitting, via an output interface, the offer amount to a local resource allocation market (LRAM). Receiving, via the input interface, a cleared price for electricity from the LRAM from which the electrical device receives electricity. Computing, a retail price of electricity for operating the electrical device based at least in part on the user selected desired operating level, and current environmental data, the cleared price for electricity from the LRAM and stored historical data from the energy futures market used to determine inter-temporal correlation behaviors of past user selected desired operating levels by the user, past pricing for electricity in a retail electricity market (REM) and past clearing pricing for electricity by the LRAM, to obtain the retail price. Wherein the computation of the offer amount and the retail price are computed jointly. Comparing the submitted offer amount to the retail price. Activating or deactivating the electrical device based on the comparison.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1A is a block diagram illustrating a method for controlling an operation of an electrical device in a market-based resource allocation system, according to embodiments of the present disclosure;

FIG. 1B is a schematic illustrating components and steps of controlling an operation of an electrical device in a market-based resource allocation system, according to embodiments of the present disclosure;

FIG. 1C is a block diagram illustrating the relationship between a load serving entity (LSE), an independent system operator (ISO), and the end use customers (EUCs), according to some embodiments of the present disclosure;

FIG. 2 is a block diagram illustrating some steps in the method for determining a joint bidding and pricing plan for a load serving entity, according to some embodiments of the present disclosure;

FIG. 3 is a schematic illustrating the interaction between the ISO, the LSE, and the EUCs, according to some embodiments of the present disclosure;

FIG. 4A is a schematic illustrating the timeline of actions in the real-time market for interval t under synchronized action mechanism between WEM and REM, according to some embodiments of the present disclosure;

FIG. 4B is a schematic illustrating the timeline of actions in the real-time market for interval t under asynchronized action mechanism between WEM and REM, according to some embodiments of the present disclosure;

FIG. 5 is a schematic illustrating the configurations of FNN and RNN that used for modeling bid/price response functions, according to some embodiments of the present disclosure;

FIG. 6 is a schematic illustrating the structure of an LSTM unit, according to some embodiments of the present disclosure;

FIG. 7A is a diagram illustrating the actor-critic structure and interaction of components used in the joint bidding and pricing algorithm under synchronized action mechanism, according to some embodiments of the present disclosure;

FIG. 7B is a diagram illustrating an alternative actor-critic structure and interaction of components used in the joint bidding and pricing algorithm under synchronized action mechanism, according to some embodiments of the present disclosure;

FIG. 8A is a diagram illustrating the actor-critic structure and interaction of components used in the joint bidding and pricing algorithm under asynchronized action mechanism, according to some embodiments of the present disclosure;

FIG. 8B is a diagram illustrating an alternative actor-critic structure and interaction of components used in the joint bidding and pricing algorithm under asynchronized action mechanism, according to some embodiments of the present disclosure;

FIG. 9A is a diagram illustrating the cumulative rewards under baseline policies and Reinforcement Learning (RL) policy, according to some embodiments of the present disclosure;

FIG. 9B is a diagram illustrating the wholesale and retail energy prices under RL policy during a typical day, according to some embodiments of the present disclosure;

FIG. 9C is a diagram illustrating the bid quantities and aggregate energy consumptions during a typical day, according to some embodiments of the present disclosure;

FIG. 9D is a diagram illustrating the impacts of discount factor on cumulative rewards, according to some embodiments of the present disclosure;

FIG. 10A is a schematic illustrating a computing apparatus that can be used to implement some techniques of the methods and systems, according to embodiments of the present disclosure; and

FIG. 10B is a block diagram illustrating some components that can be used for implementing the systems and methods, according to embodiments of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The present disclosure relates to electric power systems, and more particularly to optimal joint bidding and pricing of load serving entity.

According to an embodiment of the present disclosure, a system to control operation of an electrical device in a market-based resource allocation system. The system having a processor configured, in as close to real-time, to receive, via a transceiver, a user selected desired operating level of an electrical device by a user for an upcoming time interval. The processor connected to a memory having executable programs and stored data. The system includes computing, using the processor, an offer amount representative of a value at which electricity is available to be supplied to operate the electrical device for the upcoming time interval at the user selected desired operating level. Wherein computing the offer amount is based on multiple factors for the upcoming time interval, including: the user selected desired operating level, current environmental data, and stored historical energy futures market data used to determine inter-temporal correlation behaviors of past offer amounts to a local resource allocation market (LRAM) and past clearing pricing for electricity by the LRAM, to obtain the offer amount. Transmit, via the transceiver, the offer amount to the LRAM. Receive, via the transceiver, a cleared price for electricity from the LRAM from which the electrical device receives electricity. Compute, using the processor, a retail of electricity for operating the electrical device based at least in part on: the user selected desired operating level; and the current environmental data; the cleared price for electricity from the LRAM; and the stored historical data from the energy futures market used to determine inter-temporal correlation behaviors of past user selected desired operating levels by the user, past pricing for electricity in a retail electricity market (REM) and the past clearing pricing for electricity by the LRAM; to obtain the retail price. Wherein the computation of the offer amount and the retail price are computed jointly. Compare the submitted offer amount to the retail price. Activate or deactivate the electrical device based on the comparison.

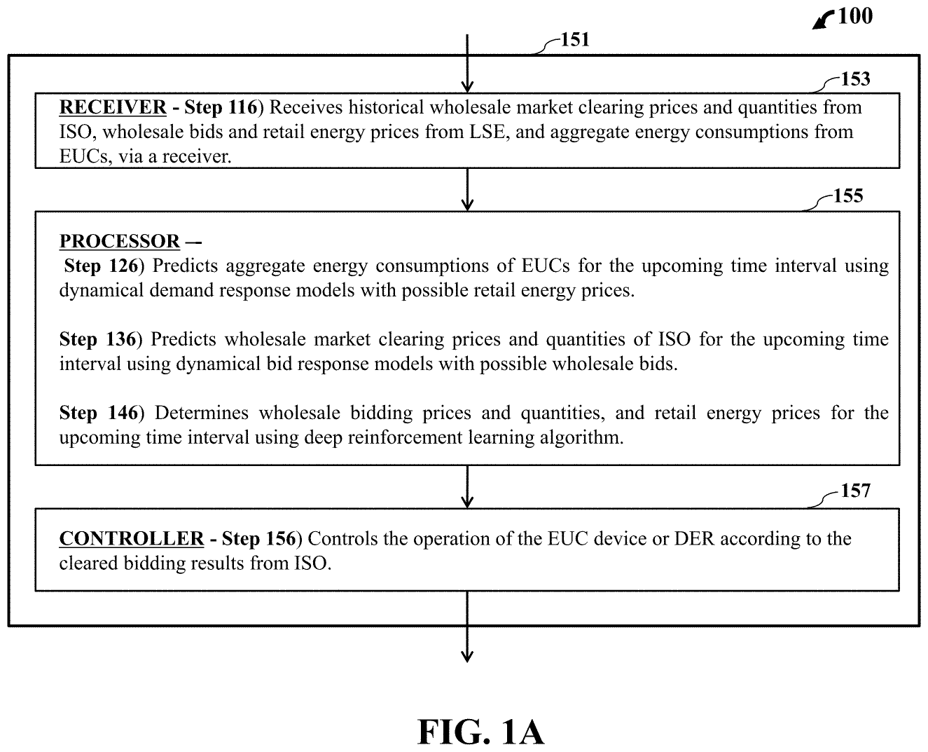

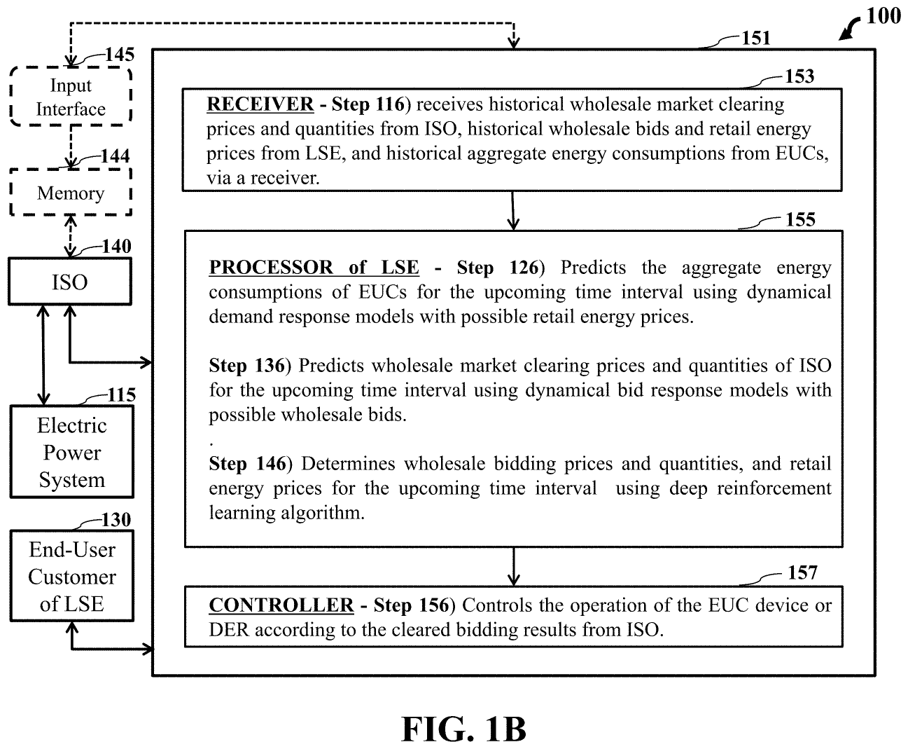

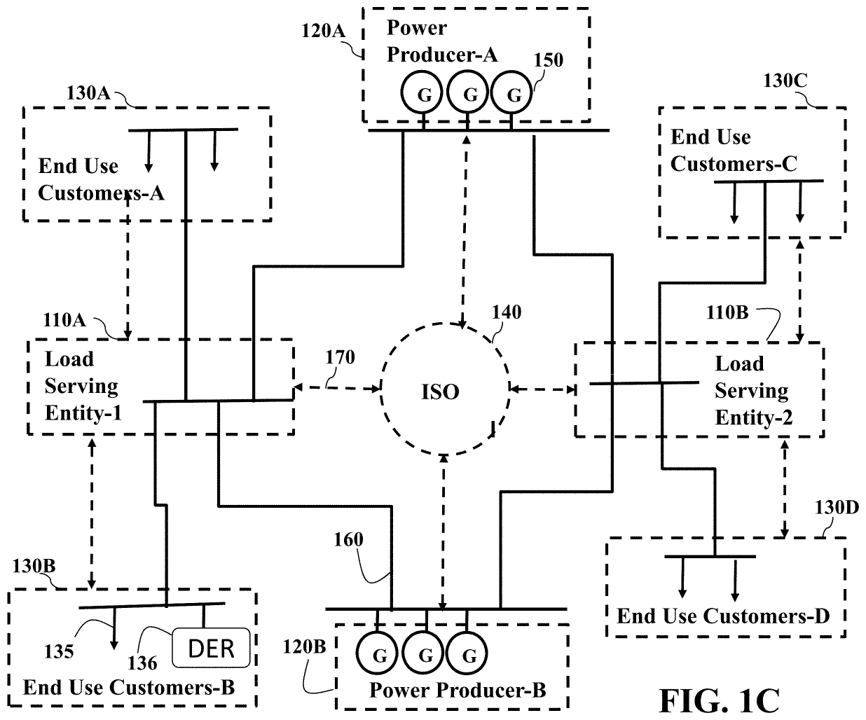

FIG. 1A is a block diagram illustrating a method for controlling an operation of an electrical device in a market-based resource allocation system, according to embodiments of the present disclosure.

Step 116 of FIG. 1A, includes receiving, via a receiver 153, receives historical market clearing prices and quantities from the ISO, wholesale bids and retail energy prices from LSEs, and aggregate energy consumption from EUCs.

Step 126 of FIG. 1A, includes a processor 155 in communication with the receiver 153, is configured to predict the aggregate energy consumption of EUCs for the upcoming time interval using dynamical demand response models with possible LSE retail energy prices.

Step 136 of FIG. 1A, is processed using the processor 155 to predict market clearing prices and quantities of ISO for the upcoming time interval using dynamical bid response models with possible LSE wholesale bids.

Step 146 of FIG. 1A, is processed using the processor 155 to determine wholesale bidding prices and quantities, and retail energy prices for the upcoming time interval using deep reinforcement learning algorithm.

Step 156 of FIG. 1A, includes a controller 157 that can be used to control the operation of the EUC device 135 or DER 137 according to the cleared bidding results from the ISO.

Embodiments of the present disclosure provide unique aspects, by non-limiting example, a specific learning period may include historical data going back in time, for example, one month, two months, six months to empirically determined a solution. However, the above specific learning period is not limited to any stated learning period, some aspects in determining a specific learning period can include, by non-limiting example, a level of accuracy in a set of earlier time frames. Further, upon considering user inputs on desired operating levels, then some methods of the present disclosure can determine possible offer amount and possible retail price, followed by a comparison of offer amount and retail price, and ultimately a decision to activate or deactivate the device. At least one aspect some of the methods and systems of the present disclosure may be applied to demand response aggregators.

FIG. 1B is a schematic illustrating components and steps of controlling of an end use customer of LSE, according to some embodiments of the present disclosure. The LSE 110 receives electricity from the electric power system 115 that can be operated by an independent system operator (ISO) 140. The control system of a EUC 130 can include a computer 151 or like device, or multiple computers. It is contemplated the computer(s) can be located at different locations, and in communication with each other. Further, other components of the computer may be located at other locations, but are connected via a network, or some like arrangement.

Still referring to FIG. 1B, the receiver 153 of the EUC control system receives historical market clearing prices and quantities from the ISO, wholesale bids and retail energy prices from the LSEs, and aggregate energy consumptions from the EUCs (step 116).

The processor 155 then, in communication with the receiver 153, predicts the aggregate energy consumptions of EUCs for the upcoming time interval using dynamical demand response models with possible LSE retail energy prices (Step 126), and predicts market clearing prices and quantities of ISO for the upcoming time interval using dynamical bid response models with possible LSE wholesale bids (Step 136).

After the possible demand and bid responses are obtained, the processor 155 determines wholesale bidding prices and quantities, and retail energy prices for the upcoming time interval using deep reinforcement learning algorithm (step 146).

Still referring to FIG. 1B, the control system 100 of the EUC 130 of the LSE 110 sends the determined wholesale bids and retail prices for the upcoming time interval to the ISO 140 and the EUCs, and the controller 157 controls the operation of the EUC device or DER according to the cleared bidding results from ISO that is received via the receiver 153 from the ISO 140 (step 156).

Optionally, the control system of the operation of EUC devices 100 can store the system energy and price data in a computer readable memory 144, wherein the computer readable memory is in communication with the processor 155 and controller 157. Further, it is possible an input interface 145 can be in communication with the memory 144 and the processor 155 and controller 157. For example, a user via a user interface of the input interface 145 may input predicted predetermined conditions, for example, the aggregate energy consumptions of EUCs. It is contemplated the receiver, processor and controller could be a single computer system or multiple computer systems located at different locations depending on the specific application(s).

FIG. 1C is a block diagram illustrating the system of FIG. 1A, according to embodiments of the present disclosure. In particular, FIG. 1C shows an electric power system 115 under an electricity market environment. The electric power system can include a set of load serving entities (LSEs) that receives power from the system, called power buyers, 110A and 110B. Each LSE 110A and 110B may have multiple end use customers (EUCs), 130A and 130 B, 130C and 130 D. Each end use customer can have electrical devices 135 consuming the electric power, and also distributed energy resource (DER) 136 producing the electric power. The EUC that consumes the power can be called consuming EUC, and the EUC that produces the power can be called as producing EUC. The power produced by DER 136 from a producing EUC can be treated as a negative demand. The power producers 120, load serving entities 110, and end user customers 130 are connected with electric power system 115 through one or more buses, or one or more types of substation.

The electric power system 115 can also include a set of power plants, 120 A and 120 B that produces power to the system. Each power producer, 120A and 120B may have multiple generation units, or called generators, 150. The EUCs, 130A and 130 B, 130C and 130D consume the powers provided by the power plants, 120A and 120 B through the network connected by transmission lines, 160. An independent system operator (ISO), 140 is responsible for the coordination between producers and LSEs to maintain stable operation of the electric power system 115. A communication network may be used for exchanging information between the ISO 140 and the producers 120, or the LSEs 110 through communication links, 170. The LSEs 110 buys the power from the ISO 140 and resells to EUCs 130. The EUCs 130 may connect with the LSE 110 through distribution line 160 and also communicate with the LSE through communication links 170. In FIG. 1C, as an example, there are 2 LSEs 110A and 110B, 4 EUCs 130A, 130B, 130C and 130D. The LSEs determines the amount of power purchasing from the ISO, i.e. bidding policy and the price of power charging to the EUCs, i.e. pricing policy. An aspect of the present disclosure focuses on determining an optimal joint bidding and pricing strategies for the LSEs.

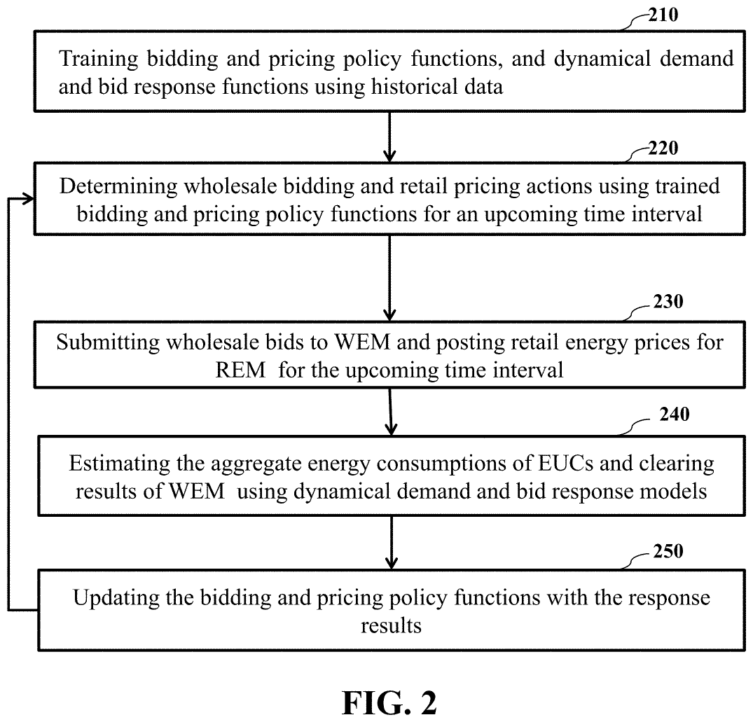

FIG. 2 is a block diagram illustrating some steps in the method for determining a joint bidding and pricing plan for a load serving entity, according to some embodiments of the present disclosure.

It includes a preparatory offline step, and a set of online steps iterating over time intervals. Before triggering real-time application, the bidding and pricing policy functions, and dynamical demand and bid response functions are trained offline using historical data, in Step 210. After this step is completed, the trained policy and response functions are used to make real-time bidding and pricing decisions for the LSE for the upcoming time intervals, iteratively. Step 220 determines the wholesale bids and the retail prices using trained bidding and pricing policy functions for an upcoming time interval. The determined wholesale bids are then sent to WEM, and the retail energy prices are posted to REM for the upcoming time interval in Step 230. Step 240 estimates the aggregate energy consumptions of EUCs and clearing results of WEM based on the bids and prices using dynamical demand and bid response functions, and the bidding and pricing policy functions are updated for performance improvements with the response results in Step 250, accordingly.

Some embodiments of the present disclosure include an MDP formulation that is developed for the joint bidding and pricing problem of the LSE, which is solved by an effective RL algorithm, the deep deterministic policy gradient (DDPG) algorithm. Dynamical bid response and price response functions represented by neural networks are learned from historical data to model the WEM and the EUCs, respectively. These response functions explicitly or implicitly capture the inter-temporal correlations of the WEM clearing results and the EUCs, and are utilized to generate state transition samples required by the DDPG algorithm without any cost.

Wholesale and Retail Energy Market Models

In an electric power industry, a load serving entity (LSE) needs to submit bids for electricity/energy in a wholesale electricity market (WEM), which is operated by an independent system operator (ISO), so as to meet the demand from its end use customers (EUCs). An LSE may determine a real-time energy price in the retail electricity market (REM) it operates to incentivize the EUCs changing their energy consumption behaviors in a way that benefits the LSE. In this context, in addition to the bidding problem, the LSE is also faced with the pricing problem, i.e. the determination of the energy price that is charged to the EUCs.

Some embodiments of the present disclosure include the joint bidding and pricing problem to be formulated as a Markov decision process (MDP), in which the energy bid and the energy price are two actions that share a common objective. Doing so allows the consideration of an accumulative profit of the LSE in the long-term. To solve this MDP without the necessity to knowing the WEM and EUC models, the deep deterministic policy gradient (DDPG) algorithm, a policy-based reinforcement learning (RL) algorithm, is applied to learn the bidding and pricing policies, which determine the optimal action from the state. The models of other market participants in the WEM and all EUCs in the REM are not known in advance. To this end, neural networks are applied to learn a bid response function and a price response function from historical data to model the WEM and the collective behavior of the EUCs, respectively, from the perspective of the LSE. These response functions can explicitly capture the inter-temporal correlations of the WEM clearing results and the EUC responses, and can be utilized to generate state transition samples without any cost. More importantly, they also inform the choice of the states in the MDP formulation.

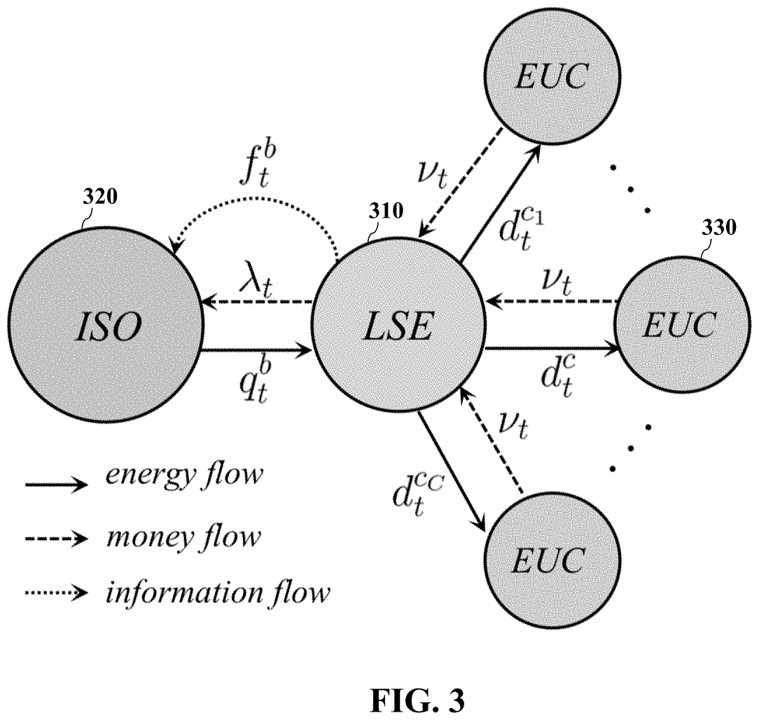

FIG. 3 is a schematic illustrating the interaction between the ISO, the LSE, and the EUCs, according to some embodiments of the present disclosure. For example, some embodiments of the present disclosure include a hierarchical market model which consists of a WEM operated by an ISO, a REM managed by an LSE, and a set of EUCs. FIG. 3 illustrates the interaction between the LSE 310, the ISO 320, and the EUCs 330. The notation used in this FIG. 3 will be introduced later. Throughout this disclosure, all vectors and matrices are in bold and italics. A subscript t indicates the value of a variable at time interval t.

Assume one day is decomposed into T time intervals indexed by the elements in the set [symbol] ={0, . . . , T−1}. Let t index the time intervals; then t mod T∈ [symbol] , where mod denotes the modulo operation. Typically, the duration of one interval may be 5, 15, 30, or 60 minutes, depending on the specific market. This disclosure only focuses on the activities that take place in the real-time energy market.

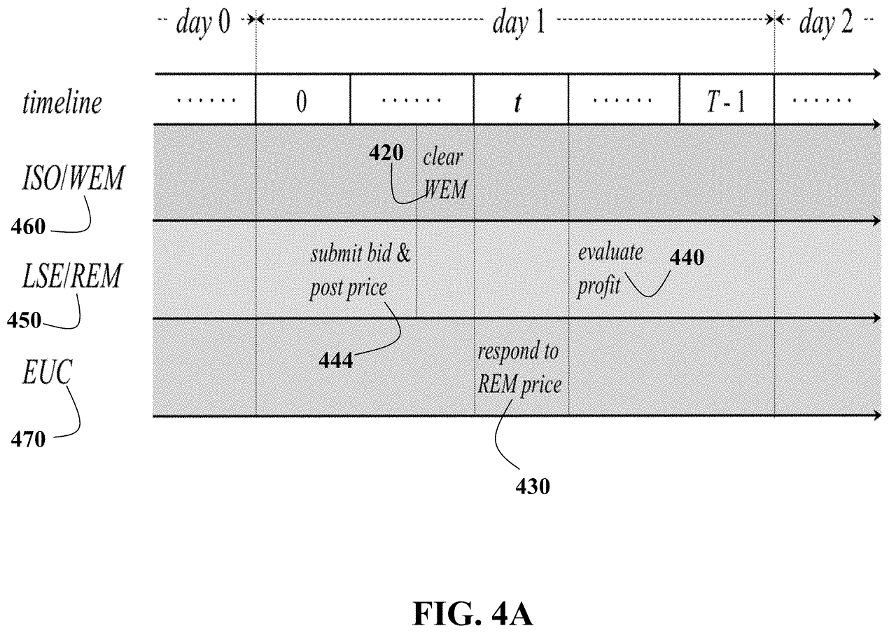

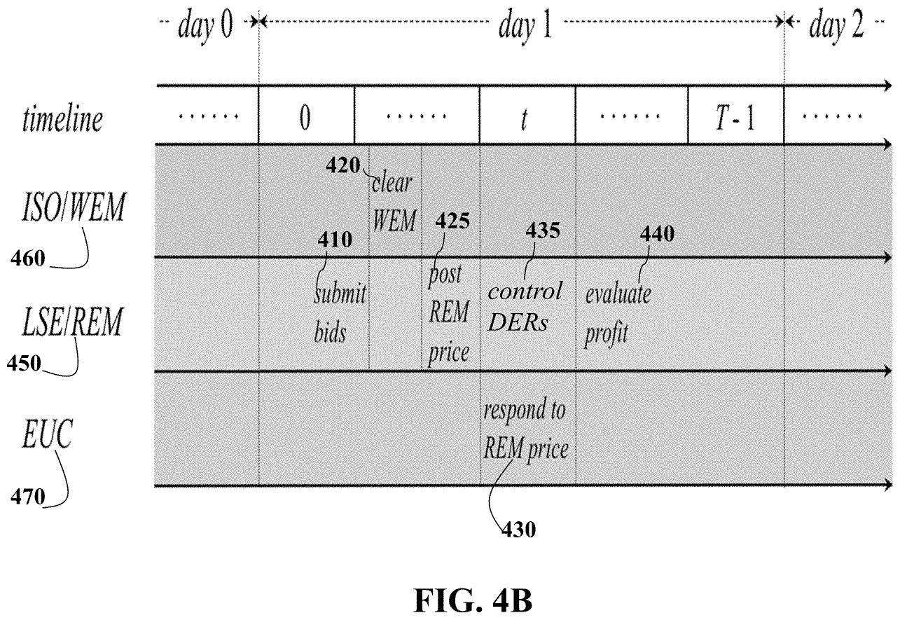

FIG. 4A is a schematic illustrating the timeline of actions in the real-time market for interval t under synchronized action mechanism between WEM and REM, according to some embodiments of the present disclosure. FIG. 4B is a schematic illustrating the timeline of actions in the real-time market for interval t under asynchronized action mechanism between WEM and REM, according to some embodiments of the present disclosure. Wherein, FIG. 4A and FIG. 4B illustrates the sequence of actions taken by different parties in the real-time market, i.e. FIG. 4A is a synchronized action mechanism between WEM and REM, and FIG. 4B, when in contract, is a asynchronized action mechanism between WEM and REM.

Prior to time interval t, each market participants, including the sellers and buyers, need to submit energy offers/bids 410 for time interval t. Then, a WEM 460 is cleared 420 to yield a wholesale energy price, as well as the energy sales and purchases that are successfully cleared for each seller and buyer, respectively. In the meantime, the LSE 450, which is a buyer in the WEM 460, also determines a retail energy price (simply referred to as the price) 425 for time interval t, at which it resells the energy to its customers, i.e., the EUCs 470, in the REM 450. During time interval t, the EUCs 470 respond to the price signal 430 by adjusting their energy consumptions. The LSE 450 needs to make payments to the ISO 460 for the energy consumed by the EUCs 470; meanwhile, it also collects payments from the EUCs 470. The total amount of profit resulted from energy trading in these two markets can be evaluated 440 after time interval t. This process is repeated for all the time intervals.

Still referring to FIG. 4A and FIG. 4B, using a synchronized action mechanism, an LSE determines its actions for WEM and REM at the same time 444, and the amount and price of purchasing/reselling power may also be matched each other between wholesale and retail markets. Using asynchronized action mechanism, the determination of WEM actions and REM actions, 410 and 425 can be determined at different times. Meanwhile, the amount and price of purchasing/reselling power can be different between wholesale and retail markets. Moreover, additional step, such as controlling DERs 435 may be needed to balance the mismatches between two sets of actions.

The wholesale market consists of a set of sellers and a set of buyers. Let [symbol] ={g₁, . . . , g_{G}} denote the set of the sellers, and [symbol] ={b, . . . , b_{B}} the set of buyers. Each seller g∈ [symbol] submits an offer (i.e. inverse supply function), denoted by fₜ^{g}(⋅), which specifies the minimum price at which it is willing to sell energy during time interval t. Specifically, fₜ^{g}(qᵣ^{g}) is the minimum price at which seller g is willing to sell energy during time interval t with a quantity of qₜ^{g}. Similarly, each buyer b∈ [symbol] submits a bid (i.e. inverse demand function), denoted by fₜ^{b}(⋅), that specifies the maximum price at which it is willing to buy energy during time interval t. Specifically, fₜ^{b}(qₜ^{b}) is the maximum price at which a buyer is willing to buy energy during time interval t with a quantity of qₜ^{b}.

Still referring to FIG. 4A and FIG. 4B, then, assuming the bulk power system is lossless and congestion-free, the ISO clears the WEM by solving the following social welfare maximization problem:

$$\begin{matrix}{maximize}_{\begin{matrix}{q}_{t}^{{g}_{1}} , … , {q}_{t}^{{g}_{G}} \\ {q}_{t}^{{b}_{1}} , … , {q}_{t}^{{b}_{B}}\end{matrix}} {\sum }_{b ∈ ℬ} {\int }_{0}^{{q}_{t}^{b}} {f}_{t}^{b} ( q ) d q - {\sum }_{g ∈ 𝒢} {\int }_{0}^{{q}_{t}^{g}} {f}_{t}^{g} ( q ) d q , \\ subject to & ( 1 a ) \\ {\sum }_{b ∈ ℬ} {q}_{t}^{b} - {\sum }_{g ∈ 𝒢} {q}_{t}^{g} = 0 ↔ {λ}_{t} , & ( 1 b ) \\ {q}_{t}^{{g}_{1}} , … , {q}_{t}^{{g}_{G}} , {q}_{t}^{{b}_{1}} , … , {q}_{t}^{{b}_{B}} ∈ , & ( 1 c )\end{matrix}$$

where (1b) is the power balance equation, λₜ is the dual variable associated with constraint (1b), [symbol] is the feasible set of the decision variables, which may depend on the market clearing results in the previous time interval. Constraint (1c) can capture all physical constraints such as capacity limits, energy limits, ramp rate limits, as well as security constraints such as reserve requirement, and line flow limits. For convenience, denote the total cleared energy sales/purchases by qₜ, i.e., qₜ= [symbol] qₜ^{b}= [symbol] qₜ^{g}.

The solution to (1) gives cleared energy sales and purchases, as well as the wholesale energy price for each market participant. In a uniform pricing market, all market participants receive a uniform price that equals to λₜ. When the WEM is competitive, a single market participant typically does not have the capability to influence the clearing price and the chances that it is the marginal unit are low. In such a setting, given λₜ, the cleared energy purchase for the buyer b when it is non-marginal, can be computed as follows:

$${q}_{t}^{b} = arg {max}_{{q}^{b}} {q}^{b} {\vert}_{{f}_{t}^{b} ( {q}^{b} ) \geq {λ}_{t}} . \qquad ( 2 )$$

Still referring to FIG. 4A and FIG. 4B, the WEM clearing problem (1) is a deterministic problem, in the sense that given the inverse supply and demand functions, the clearing quantities and prices are determined deterministically. However, these functions may vary in different time intervals since the market participants may adjust their strategies based on the observed market clearing results.

It is noted that the disclosed methodology can be easily extended to handle cases when losses and transmission line congestions are considered. As an example, the simple yet representative case is presented here with the hope to provide more insights.

In the WEM, the LSE participates as a buyer that purchases energy through bidding. Without loss of generality, assume the LSE under consideration is buyer b in the WEM. The LSE resells the purchased energy to a set of EUCs in the Retail Energy Market (REM) and charges them at a typically regulated price that it needs to determine. Let νₜ denote the price at time interval t, and qₜ^{b} the energy purchased from the WEM.

Let [symbol] ={c₁, . . . , c_{c}} denote the set of the EUCs in the REM served by this LSE. For EUC c∈ [symbol] , it will respond to the price νₜ by adjusting its energy consumption, denoted by dₜ^{c}. Denote the aggregate energy consumption of all EUCs measured at the substation during time interval t by dₜ, i.e., dₜ= [symbol] dₜ^{c}. Then, the objective of the LSE is to maximize its profit earned from time interval t and onwards, subject to the energy balance constraint, which can be mathematically express as follows:

$${maximize}_{{v}_{t} , {v}_{t + 1} , … ∈ [ \underline{v} , \overline{v} ]} 𝔼 [ {\sum }_{τ = t}^{∞} {γ}^{τ - t} ( ( {v}_{τ} - {λ}_{τ} ) {d}_{τ} - {φ}_{τ} ( {d}_{τ} - {q}_{τ}^{b} ) ) ] , \qquad ( 3 )$$

where [symbol] denotes expectation operation, γ∈[0, 1] is a discount factor that discounts the future profit (i.e., expectation of future profits in regard to Eq. 3), ϕᵣ(⋅) is a non-negative scalar function that computes the cost incurred when the aggregate energy consumption deviates from the energy purchase, ν and ν̅ are the minimum and maximum prices, respectively. Note that λ_{τ} and q_{τ}^{b} are determined by the WEM through (1), while d_{τ} is determined by the EUCs through (4). The earned profit from resells can also be determined as (ν_{τ}d_{τ}−λ_{τ}q_{τ}^{b}) if payments to ISO is computed based on cleared energy purchase q_{τ}^{b}, for example, in a day-ahead market.

The buyers for the REM are end use customers. At the beginning of each time interval t, EUC c, c∈ [symbol] receives a price νₜ from the LSE, it will then optimize its energy consumption so as to maximize its overall benefit. A generic EUC model is agnostic to the underlying components. Let eₜ^{c} denote the energy need of EUC c at time interval t. A myopic EUC finds its optimal action via solving the following utility maximization problem:

$$\begin{matrix}{maximize}_{{d}_{t}^{c} ∈ {𝒟}_{t}^{c}} {β}^{c} ( {e}_{t}^{c} , {d}_{t}^{c} ) - {v}_{t} {d}_{t}^{c} , \\ subject to & ( 4 a ) \\ {e}_{t + 1}^{c} = {e}_{t}^{c} + {η}_{t}^{c} ( {e}_{t}^{c} - {d}_{t}^{c} ) + {ξ}_{t}^{c} , & ( 4 b )\end{matrix}$$

where β^{c}(⋅) is the benefit function, which gives the benefit of the EUC at certain energy need and energy consumption, ηₜ^{c}∈[0, 1] is the backlog rate that represents the percentage of unmet energy need that is carried over to the next time interval, ξₜ^{c} is a random variable that models that newly generated incremental energy need, [symbol] ₜ^{c} is the feasible set of the energy consumption.

[symbol]

Joint Bidding and Pricing Problem Formulation Under Synchronized Action Mechanism

Some embodiments of the present disclosure include address the problem of jointly determining the energy bid that is submitted to the wholesale electricity market (WEM) and the energy price that is charged in the retailed electricity market (REM) for a load serving entity (LSE), which seeks to maximize its total profits. The joint bidding and pricing problem is formulated as a Markov decision process (MDP) with continuous state and action spaces, in which the energy bid and the energy price are two actions that share a common objective, i.e. profit maximization.

First dynamical bid and price response functions are introduced, followed by the bidding and pricing policies. Then, we formulate the joint bidding and pricing problem faced by the LSE as an MDP.

From the perspective of the LSE, it has to determine a bid fₜ^{b}—the bidding problem, as well as a price νₜ—the pricing problem, for time interval t. Assume fₜ^{b} is characterized by a parameter vector ωₜ. Let {λ_{τ}, q_{τ}}ₜ₋ₙ_{₁}^{t-1} denote the set of WEM clearing results from time interval t−n₁ to t−1. Then, we model the interaction between the LSE and the WEM defined through (1) using a n₁-order bid response function, denoted by ψ(⋅), as follows:

(Δₜ,qₜ,qₜ^{b})=ψ({λ_{τ},q_{τ},q_{τ}^{b}}ₜ₋ₙ_{₁}^{t-1},ωₜ,t mod T), (5)

where (t mod T) is included to model the time dependence. The cleared energy purchase can be computed using (2). For a perfectly competitive WEM, ωₜ has negligible impacts on the clearing results, and (5) essentially models the dynamics of the clearing results. The core idea behind the bid response function is the following. Assume all market participants make decisions for time interval t based on the WEM clearing results for previous time intervals. From the perspective of the LSE, the WEM clearing results will evolve to λₜ, qₜ, qₜ^{b} from previous WEM clearing results, given its bid ωₜ. The impacts from other market participants' actions are implicitly included in this bid response function. Therefore, when n₁ is large enough, the n₁-order bid response function can well capture the dynamics in the WEM.

In the meantime, the LSE may only have information on the aggregate energy consumption dₜ in real-time, rather than complete parameters in (4).

Therefore, instead of adopting the complete EUC model in (4), we use a n₂-order price response function, denoted by ϕ(⋅), to characterize the collective behavior of all EUCs defined through the set of problems in (4), as follows:

dₜ=ϕ({d_{τ},υ_{τ}}ₜ₋ₙ_{₂}^{t-1},υₜ,t mod T), (6)

In the special case when n₂=0, the aggregate energy consumption of EUCs only depends on the price at the current time interval. The core idea behind the price response function is similar to that of the bid response function. Compared to the complete WEM model and EUC models, the response functions are easier to learn from the data that are available to the LSE.

At least one objective of the joint bidding and pricing problem to be solved by the LSE is to determine the bid and the price based on available information. As discussed earlier, prior to time interval t, the information related to the WEM that is available to the LSE includes ω_{τ}, λ_{τ}, q_{τ}, q_{τ}^{b}, ∀τ≤t−1. In the meantime, the information related to the REM that is available to the LSE includes νₜ, d_{τ}, ∀τ≤t−1. Let [symbol] _{τ-1}=ω_{τ}, λ_{τ}, q_{τ}, q_{τ}^{b}, ν_{τ}, d_{τ}, {τ≤t−1} denote the set of information available to the LSE before the WEM for time interval t is cleared.

The bidding problem and the pricing problem are inherently coupled, and thus need to be considered jointly. In a uniform pricing market, the LSE's bid will get cleared as long as its bid price is no smaller than λₜ. Meanwhile, to minimize the cost incurred due to the mismatch of the energy purchase and aggregate energy consumption, it is indeed desirable to bid for the amount of energy that equals to the aggregate energy consumption. In fact, when λₜ is not affected by ωₜ, for any νₜ, the optimal bid ωₜ that maximizes the profit defined in (3) is the one that gives q_{τ}^{b}=d_{τ}. Essentially, we only need to find the optimal price νₜ for the REM, and then construct the bid from νₜ

Define a deterministic pricing policy, denoted by π(⋅), as the following function that maps [symbol] ₜ₋₁ to the price νₜ:

νₜ=π( [symbol] ₜ₋₁). (7)

Also, define a deterministic bidding policy, denoted by μ(⋅), as the following function that maps [symbol] ₜ₋₁ and νₜ to a bid ωₜ:

ωₜ=μ( [symbol] ₜ₋₁,νₜ). (8)

As an example, assume the bid ωₜ consists of two components, a bid price ωₜ^{p} in $/MWh and a bid quantity ωₜ^{q} in MWh. Then, the optimal bidding policy μ* is such that ωₜ^{p} is set to νₜ and ωₜ^{p} is set to the estimated aggregate energy consumption obtained using the price response function ϕ. Therefore, there is no additional parameter in μ that needs to be learned beyond those in ϕ.

The joint bidding and pricing problem is formulated as a Markov decision process (MDP). An MDP consists of a state space, an action space, a reward function, and a transition probability function that satisfies the Markov property, i.e., given the current state and action, the next state is independent of all states and actions in the past. Specifically, in the joint bidding and pricing problem, define the state at time interval t to be sₜ=({ω_{τ}, λ_{τ}, q_{τ}, q_{τ}^{b}}ₜ₋ₙ_{₁}^{t-1}, {d_{τ}, ν_{τ}}ₜ₋ₙ_{₂}^{t-1}, t mod T). Define the action for time interval t to be aₜ=νₜ. As discussed in the previous section, ωₜ can be constructed from νₜ through a set of deterministic procedures. Both the state and action spaces are continuous. Given sₜ and aₜ, sₜ₊₁ is determined through (5) and (6). Therefore, the Markov property is satisfied. However, the transition probability function is determined by all the market participants in the WEM as well all EUCs in the REM, and is unknown to the LSE.

Then, the pricing policy can equivalently become

νₜ=π(sₜ), (9)

and the bidding policy can be equivalently written as:

ωₜ=μ(sₜ,νₜ). (10)

The objective of the joint bidding and pricing problem is to maximize the profit of the LSE; therefore, we define the reward for time interval t to be the profit earned by the LSE as follows:

rₜ=(νₜ−λₜ)dₜ−ϕₜ(dₜ−qₜ^{q}), (11)

where ϕₜ(⋅) computes the cost incurred when the aggregate energy consumption deviates from the cleared energy purchase, as in (3). The cumulative discounted reward from time interval t and onwards, denoted by Rₜ and referred to as the return, is Rₜ=Σ_{τ=t}^{∞}γ^{τ-t}r_{τ}, where γ∈[0, 1] is a discount factor. The action value function, also referred to as the Q function, under pricing policy π and bidding policy μ, at action a and state s, denoted by Q^{π}(s, a) is the expected return defined as

Q^{π}(sₜ,aₜ)= [symbol] [Rₜ|ₛ_{ₜ}_{,a}_{ₜ}^{;π,μ}]. (12)

The Q function under optimal pricing policy π* and optimal bidding policy μ*, denoted by Q*(⋅,⋅), satisfies the Bellman optimality equation:

Q*(sₜ,aₜ)= [symbol] [rₜ]+γ∫_{S} [symbol] {sₜ₊₁|sₜ,aₜ}Q*(sₜ₊₁,aₜ₊₁), (13)

where [symbol] {sₜ₊₁|sₜ, aₜ} is the probability that the state transit into sₜ₊₁ conditioning on sₜ, aₜ; S is the state space.

Since μ* does not need to be learned once we have ϕ, the joint bidding and pricing problem essentially becomes finding π that maximize the following performance function:

J(π)= [symbol] [R₁;π,μ*], (14)

which gives the expected return under given bidding and pricing policies. The MDP problem can be solved leveraging a Reinforcement Learning (RL) algorithm be detailed later.

Learning Algorithm for Bid/Price Response

In RL algorithms, transitions (s_{τ}, a_{τ}, r_{τ}, s_{τ+1}) are critical for learning a good policy. Typically, a large number of transition samples are needed in order to learn a good policy. One approach to obtain the transitions is to sample from the actual environment online, i.e., to get samples from directly interacting with the ISO and the EUCs, till adequate samples are acquired. This approach, however, does not utilize the samples in an efficient manner. In addition, this may incur significant cost for the LSE during action exploration.

Alternatively, we can learn the bid response function ψ and the price response function ϕ from historical data and use the learned response functions as a substitute to the actual environment. The learned response functions can generalize the transition samples to new transitions, and if accurate enough, would allow the learning of good bidding and pricing policies without incurring any cost. The response function learning problems can be cast as supervised learning problems. The objective of the learning algorithm is to minimize the mean squared error between the predicted values and the actual values of the outputs.

To explicitly capture the temporal behavior of the WEMs and EUCs, the dynamical bid response and demand response models as shown (5) and (6) which have states that evolve over time are used. The states in the dynamical model keep necessary information from previous time intervals, and allows more accurate prediction of the WEM and EUC response. These states can be explicitly chosen based on (5) and (6), in which case the model can be represented by a linear function or a multi-layer feedforward neural network (FNN), or implicitly chosen, in which case the model can be represented by a recurrent neural network (RNN) or a long short-term memory (LSTM) unit network.

The bid response model is used to express the relationship between the wholesale market clearing results with the LSE bid. It takes the market cleared results at the upcoming time interval as the output, and both the LSE bid for the upcoming interval, and wholesale market clearing results at time intervals prior to the upcoming time interval as inputs. The wholesale clearing results include the cleared prices and quantities of electricity/energy. Taking the impacts of previous wholesale market clearing results on the cleared results for the upcoming time interval, i.e. the inherent temporal correlation of wholesale market behaviors into account, reduces the mismatches between the actual bid response and the computed response using the bid response model.

Meanwhile, the price response model is used to express the relationship between the aggregate energy consumption of end use customers and the retail price. It takes the aggregate energy consumption as the output. Besides taking the electricity price as one of its input, this function also takes the aggregate energy consumption and price at previous time intervals as inputs to simulate the inherent temporal correlation of the EUC behaviors.

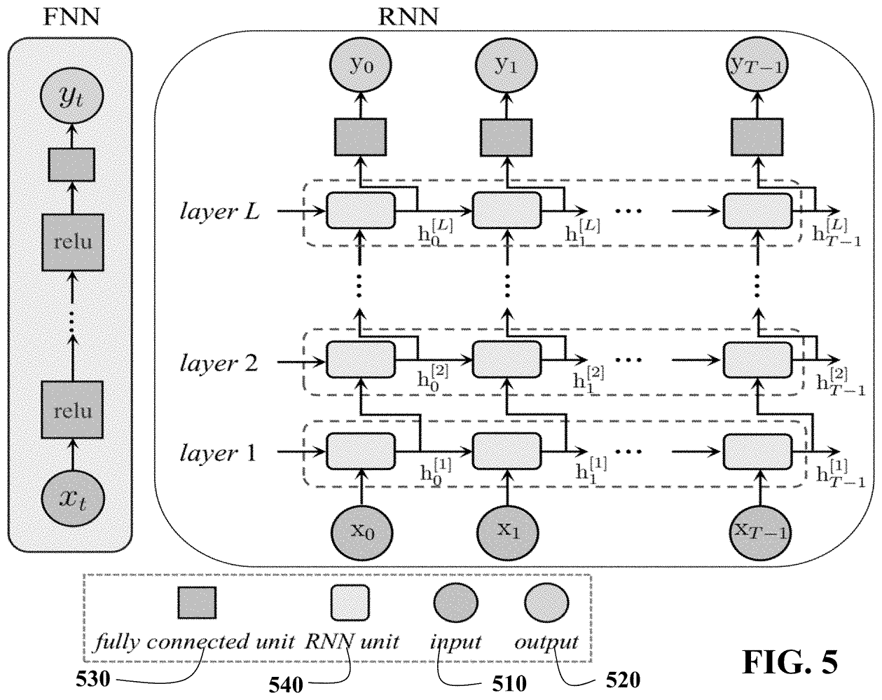

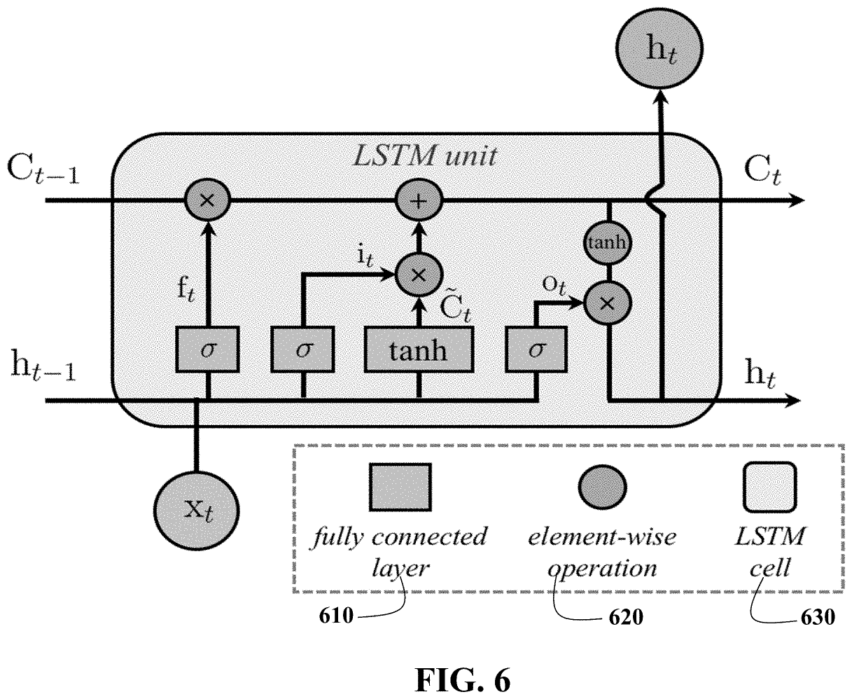

FIG. 5 is a schematic illustrating the configurations of FNN and RNN that used for modeling bid/price response functions, according to some embodiments of the present disclosure. For example, the configurations of FNN and RNN are used for modeling bid/price response functions. Four different units may be used for configuring FNN or RNN, including input unit 510, output unit 520, fully connected unit 530, and RNN unit 540. FIG. 6 illustrates the structure of an LSTM unit 630, in which fully connected layer 610, and element-wise operation 620 are used.

When using linear functions or multi-layer feedforward neural networks (FNNs), the inputs and outputs are chosen explicitly. When learning the bid response function, the inputs are ({λ_{τ}, q_{τ}, qₜ^{b}}ₜ₋ₙ_{₁}^{t-1}, t mod T) and ωₜ, and the outputs are {Δₜ, qₜ, qₜ^{b}}. When learning the price response function, the inputs are ({d_{τ}, ν_{τ}}ₜ₋ₙ_{₂}^{t-1}, t mod T) and νₜ, and the output is dₜ.

Still referring to FIG. 5, taken modeling EUC's price-based demand response as example, the dynamical demand response function ϕ expressed in (4) can be represented using, for example, a linear function as follows:

dₜ=W[sₜ^{T},νₜ]+b, (15)

where W is a weight vector, sₜ=({d_{τ}, ν_{τ}}ₜ₋ₙ_{₂}^{t-1}, t mod T), and b is the bias, the superscript T denotes the transpose of a vector or matrix.

Still referring to FIG. 5, also, we may represent ϕ with a nonlinear function such as a multi-layer FNN, which consists of one input layer, L hidden layer, and one output layer as illustrated in the left part in FIG. 5. The hidden layer l takes an input vector xₜ^{[l]} 510, and computes a (hidden) output vector hₜ^{[l]} according to:

hᵣ^{[l]}=relu(W^{[l]}xₜ^{[l]}+b^{[l]}), (16)

where relu(⋅) denotes a rectified linear unit function that is applied element-wise, W^{[l]} is a weight matrix, and b^{[l]} is a bias vector. Note that the output vector of one hidden layer is the input vector for the next hidden layer, i.e., x^{[t+1]}=h^{[l]}, except the last hidden layer, the output of which is mapped to the output through a fully connected unit as follows:

yₜ=Wh^{[L]}+b, (17)

where W is a weight matrix, and b is a bias vector. The multi-layer FNN can be trained using back-propagation algorithm such that the mean squared error between the predicted output yₜ and the true value dₜ is minimized, i.e., by minimizing the following loss function, [symbol] :

$${𝓁}^{′} = \frac{1}{{m}^{tr}} {\sum }_{i = 1}^{{m}^{tr}} {( {y}_{t} - {d}_{t} )}^{2} . \qquad ( 18 )$$

where, m^{tr} is the total number of samples for FNN training.

Alternatively, the dynamic demand response can be implicitly modeled within the neural network, which leads to RNNs, i.e. Recurrent Neural Network. The right part in FIG. 5 illustrate a multi-layer RNN with one input layer, L hidden layers, and one output layer. The hidden state of the RNN unit in layer l, denoted by hₜ^{[l]}, is the input for RNN unit in the next layer as well as the input for itself at the next time step, as indicated by the arrows in FIG. 5. This RNN takes a sequence {x₀, . . . , x_{T-1}} as the input, and outputs a sequence {y₀, . . . , y_{T-1}}. Meanwhile, L sequences of hidden states {hₜ^{[l]}}, l=1, . . . , L are generated along the trajectory, based on the following equations:

hₜ^{[l]}=tanh(Wₕ^{[l]}hₜ₋₁^{[l]}+Wₓ^{[l]}xᵣ^{[l]}+b^{[l]}), (19)

where tanh(⋅) is applied element-wise, Wₕ and Wₓ are weight matrices, b is a bias vector. Note that h₋₁^{[l]} are initialized to zeros, xₜ^{[l]}=hₜ^{[t-1]} for l=2, . . . , L, and xₜ^{[l]}=(sₜ, νₜ). The hidden states in RNN are dynamical since their values also depend on their previous values, while those in the FNN are static since their values purely depend on the inputs. The output of the last hidden state vector is mapped to the output through a fully connected unit as in the case of multi-layer FNN. The RNN can be trained by minimizing the same loss function as in (18) using backpropagation through time technique. The input vector only has to include the most-recent information, i.e., when RNN is used, n=1 and sₜ=(νₜ₋₁, dₜ₋₁, t mod T).

Still referring to FIG. 5, at least one key difference between the RNN and FNN in representing the dynamical demand response model is that the FNN captures the temporal impacts by explicitly specifying a set of historical data as inputs, while the RNN keeps the temporal impacts by implicitly computing a dynamical hidden state. One of the deficiency of the basic RNN unit is the lack of ability to model long-term dependencies. As a significant improvement over the basic RNN unit, the LSTM is used.

FIG. 6 is a schematic illustrating the structure of an LSTM unit, according to some embodiments of the present disclosure. For example, the multi-layer LSTM network is similar to the RNN in FIG. 5, wherein the RNN unit is replaced with the LSTM unit. The structure of the LSTM unit is illustrated in FIG. 6, in which σ(⋅) denotes a sigmoid function. For the purpose of simplicity, we drop the superscript that indicates the layer and focus on structure inside one LSTM unit. The LSTM unit introduces a new hidden state vector Cₜ, which is used to keep long-term memories. The LSTM unit works as follows. First, a forget gate vector fₜ, an information gate vector iₜ, and an output gate vector oₜ is computed from previous hidden state hₜ₋₁ and new input vector xₜ as follows:

fₜ=σ(W_{fh}hₜ₋₁+W_{fx}xₜ+b_{f}), (20)

iₜ=σ(Wᵢₕhₜ₋₁+Wᵢₓxₜ+bᵢ), (21)

oₜ=σ(Wₒₕhₜ₋₁+Wₒₓxₜ+bₒ), (22)

then, the two hidden state vectors are updated as follows:

[symbol]

=tanh(W_{Ch}hₜ₋₁+W_{Cx}xₜ+b_{C}), (23)

Cₜ=fₜ∘Cₜ₋₁+iₜ∘ [symbol] , (24)

hₜ=oₜ∘tanh(Cₜ), (25)

where ∘ represents element-wise multiplication. This structure has proven to be very effective in capturing long-term temporal dependencies, and therefore, is expected to outperform the basic RNN unit when representing the dynamical DR model.

Similarly, the bid response function can also be modeled using direct or indirect approaches as demand response function.

Still referring to FIG. 5 and FIG. 6, using dynamical models, the bid or price response characteristics of the ISO or EUCs, which are inherently temporally correlated can be accurately considered in the process of LSE bidding and pricing. Among above-mentioned approaches, FNN, RNN, and LSTM outperforms the linear function, at the cost of higher model complexity. In particular, when RNN or LSTM is used, no manual selection of states is required.

Learning Algorithm for Bidding/Pricing Policies Under Synchronized Action Mechanism

After obtained the bid and price response functions, we can next discuss the learning algorithms for pricing policy π. Since the optimal bidding policy can be directly derived from the bid response function, therefore no additional parameter in the bidding policy μ needs to be learned beyond those in ϕ. Assume π is parameterized by a vector θ^{π}. Then, finding the optimal pricing policy is essentially finding the optimal value for θ^{π}. One type of RL algorithms that can find (sub-optimal) values for θ^{π} is the policy gradient methods, which update the parameter vector in the direction that maximizes performance function, J(π). The gradient of J can be computed according to the Deterministic Policy Gradient Theorem. Specifically, the gradient of J with respect to θ^{π}, referred to as the action gradient, is as follows:

∇_{θ}_{^{π}}J= [symbol] [∇ₐQ(s,a)∇_{θ}_{^{π}}π(s)]. (26)

Note that the gradient of the performance function J depends on the action value function Q, which is not known and needs to be estimated. The deep deterministic policy gradient (DDPG) based RL algorithm is used for solving the joint bidding and pricing optimization problem.

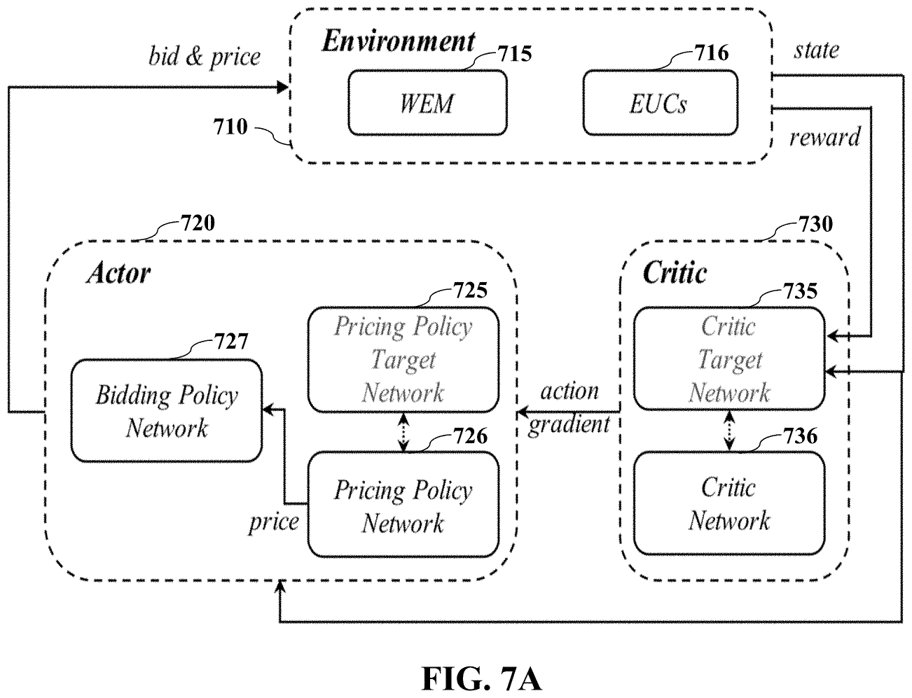

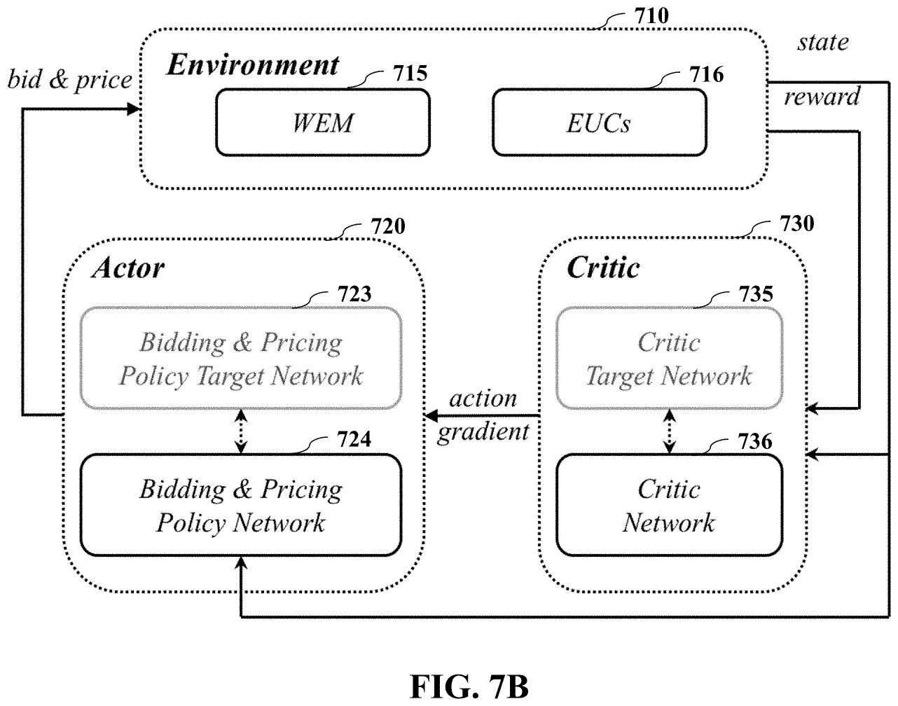

FIG. 7A is a diagram illustrating the actor-critic structure and interaction of components used in the joint bidding and pricing algorithm under synchronized action mechanism, according to some embodiments of the present disclosure. For example, FIG. 7A shows the structure of DDPG algorithm and the interaction of each component in the algorithm. In the DDPG algorithm, the actor-critic architecture is adopted, in which a critic 730 is used to estimate the Q function, and an actor 720 is used to estimate the policy. Neural networks as adopted to approximate these functions. Specific to the joint bidding and pricing problem, we represent the Q function by a neural network-referred to as the critic network 736—with a parameter vector θ^{Q}. The parameters of the critic network can be estimated using methods such as temporal-difference learning. Meanwhile, the pricing policy is represented by a neural network-referred to as the pricing policy network 726—with a parameter vector θ^{π}. The bidding policy is also represented by a neural network 727, which consists of the learned bid response function. The bidding and pricing policy networks are collectively referred to as the actor networks. The parameters of the pricing policy network can be estimated using the policy gradient method.

In addition to using the neural networks, there are two more important ideas in the DDPG algorithm. First, target networks, the parameters of which slowly track those of the actor network and the critic network, are used to stabilize the algorithm. The parameter vector of the target network for the critic 735 is denoted by θ^{Q′}, and that of the pricing network 725 is denoted by θ^{π′}. Second, a replay buffer [symbol] is used to store the transitions of the MDP and at each time instance, a mini-batch of size m is sampled from the [symbol] and used to estimate the gradients. Note that in the training stage, response functions are used to substitute the WEM 715 and EUCs 716. The WEM 715 and EUCs 716 constitute the environment 710. The behaviors of WEM and EUCs can be represented using actual data/measurements during real-time application and can also be simulated using bid and price response functions for training or predicting purposes.

Still referring to FIG. 7A, the detailed DDPG based RL algorithm for solving the joint bidding and pricing problem is presented in Algorithm 1. At each step, θ^{Q} is updated in the direction that minimizes the following loss function, [symbol] :

$$𝓁 = \frac{1}{m} {\sum }_{i} {( {r}_{i} + γ {Q}^{′} ( {s}_{i + 1} , {π}^{′} ( {s}_{i + 1} ) ) - Q ( {s}_{i + 1} , {a}_{i + 1} ) )}^{2} . \qquad ( 27 )$$

The intuition behind this is to actually find a critic network that satisfy the Bellman optimality equation in (13). Note that the target networks are used to compute the action value as well as the next action, i.e., π′ (sᵢ₊₁). Meanwhile, θ^{π} is updated in the direction that maximizes performance function, J, specifically, the direction of action gradient that is approximated using samples as follows:

$${∇}_{{θ}^{π}} J \approx \frac{1}{m} {\sum }_{i} {∇}_{a} Q ( {s}_{i} , {a}_{i} ) {∇}_{{θ}^{π}} π ( {s}_{i} ) . \qquad ( 28 )$$

Algorithm 1: DDPG-based Policy Learning Algorithm

Input: ψ, ϕ, α^{a}, α^{c}, M, m
Output: π

| | |
|---|---|
| 1. | Randomly initialize critic network Q(s, a) and actor network π(s), with weights θ^{Q} and θ^{π}, respectively. |
| 2. | Initialize target networks Q′, and π′, with weights θ^{Q′} ← θ^{Q} and θ^{π′} ← θ^{π}, respectively. |
| 3. | Initialize replay buffer [symbol] |
| 4. | for episode = 1, . . . , M do |
| 5. | Initialize a random process ζ for price exploration |
| 6. | Receive initial state s₀. |
| 7. | for τ = 0, . . . , T − 1 do |
| 8. | Select a retail energy price according to ν_{τ} = π(s_{τ}) + ζ_{τ} |
| 9. | and a wholesale bid according to ω_{τ} = μ*(s_{τ}, ν_{τ}) |
| 10. | Obtain λ_{τ}, q_{τ}, q_{τ}^{b} from (λₜ, qₜ, qₜ^{b}) = ψ({λ_{τ}, q_{τ}, q_{τ}^{b}}ₜ₋ₙ_{₁}^{t-1}, ωₜ, t mod T), and d_{τ} from d_{τ} = |
| | ϕ({d_{τ}, υₜ}ₜ₋ₙ_{₂}^{t-1}, t mod T) |
| 11. | Compute reward r_{τ} according to r_{τ} = (ν_{τ} − λ_{τ})d_{τ} − ϕ_{τ}(d_{τ} − q_{τ}^{q}) |
| 12. | Store transition (s_{τ}, a_{τ}, r_{τ}, s_{τ+1}) into [symbol] |
| 13. | Sample from [symbol] a mini-batch of m transitions (sᵢ, aᵢ, rᵢ, sᵢ₊₁) if \| [symbol] \| > m else continue |
| 14. | Update critic network by minimizing [symbol] , |
| | $𝓁 = \frac{1}{m} {\sum }_{i} {( {r}_{i} + γ {Q}^{′} ( {s}_{i + 1} , {π}^{′} ( {s}_{i + 1} ) ) - Q ( {s}_{i + 1} , {a}_{i + 1} ) )}^{2} \text{:} {θ}^{Q} = {θ}^{Q} - {α}^{c} {∇}_{ {θ}^{Q}} 𝓁$ |
| 15. | Update actor network by maximizing J, J (π) = [symbol] [R₁; π, μ*] using sampled gradients, |
| | ${∇}_{ {θ}^{π}} J = \frac{1}{m} {\sum }_{i} {∇}_{ a} Q ( {s}_{i} , {a}_{i} ) {∇}_{ {θ}^{π}} π ( {s}_{i} ) \text{:} {θ}^{π} = {θ}^{π} + {α}^{a} {∇}_{ {θ}^{π}} J$ |
| 16. | Update target networks: |
| | θ^{Q′} ← ρθ^{Q} + (1 − ρ)θ^{Q′}, |
| | θ^{π′} ← ρθ^{π} + (1 − ρ)θ^{π′} |
| 17. | End for τ |
| 18. | End for episode |

Still referring to FIG. 7A, the algorithm 1 is designed to determine pricing policy and bidding policy by using one neural network for each policy individually according to FIG. 7A. α^{a} and α^{c} are the learning rates for the pricing policy network and the critic network. ρ is the update rate for the target networks. m is the size of the mini-batch, and M is total number of episodes used for policy training. γ is the discount rate.

The computing retail energy price is achieved in Step 8 as the output of the pricing policy function when the state collected from the environment is available and take as the input. The pricing policy function is represented by the pricing policy network, wherein the pricing policy network is implemented as a neural network.

The computing wholesale bid is achieved in Step 9 as the output of the bidding policy function when the retail energy price, and the state collected from the environment are taken as the input. The biding policy function is represented by the bidding policy network which implemented as a neural network as well. The wholesale bid may include one or more pairs of bid prices and bid amounts, or a function to represent the relationship of bid price and bid amount. The wholesale bid price is also referred as “LSE offer amount” in this disclosure.

The configurations or parameters of critic and actor networks, and critic and actor target networks are adaptively updated with latest information in Steps 10-16.

It is noted that only steps 8-16 are required for computing wholesale bids and retail energy prices for the upcoming time interval r when it is used for real-time application. Meanwhile, the wholesale cleared results and the EUCs aggregate energy consumption used in Step 10 can be replaced with actual data if the actual measurements or information can be collected timely.

It is also worth to mention that a FNN is used for constructing the required neural networks, when a finite number of previous time intervals is used, and a RNN or a LSTM network is used, when all available previous time intervals are used.

Although we only give details for DDPG algorithm based on the DDPG structure given in FIG. 7A, the algorithm can be easily extended to any variations to the DDPG structure. FIG. 7B is a diagram illustrating an alternative actor-critic structure and interaction of components used in the joint bidding and pricing algorithm under synchronized action mechanism, according to some embodiments of the present disclosure. For example, the bidding and pricing policy can also be determined by using only one neural network to estimate two policies collectively, wherein a composite bidding and pricing policy network 724, and associated a composite bidding and pricing target policy network 723 can be used to produce bidding and pricing actions jointly.

Joint Bidding and Pricing for LSE Under Asynchronized Action Mechanism

The above algorithms are devised by assumed that the synchronized action mechanism is used when jointly determining WEM and REM actions. If an asynchronized action mechanism as shown in FIG. 4B is used, above algorithms need to be modified accordingly.

FIG. 4B shows an alternative market setting for WEM and REM compared with FIG. 4A. The major difference between this setting and setting shown in FIG. 4A are follows. The LSE posts REM price after the WEM is cleared, therefore the LSE can have more updated information regarding WEM before determining the REM price. In addition, the LSE has the capability to control distributed energy resources 435 such as energy storage systems, which enables it to bid an energy amount to WEM different than the anticipated aggregate energy consumptions from the REM.

For such settings, the retail market model for an LSE can be formulated to maximize its profit earned from time interval t and onwards, subject to the energy balance constraint, which can be mathematically express as follows:

$${maximize}_{{v}_{t} , {v}_{t + 1} , … ∈ [ \underline{v} , \overline{v} ]} 𝔼 [ {\sum }_{τ = t}^{∞} {γ}^{τ - t} ( {v}_{τ} {d}_{τ} - {λ}_{τ} {q}_{τ}^{b} - {φ}_{τ} ( {d}_{τ} - {q}_{τ}^{b} ) ) ] , \qquad ( 29 )$$

The earned profit from resells can also be determined as (ν_{τ}d_{τ}−λ_{τ}d_{τ}) instead of (ν_{τ}d_{τ}−λ_{τ}q_{τ}^{b}), if payments to ISO is computed based on actual aggregate energy consumption d_{τ} but not q_{τ}^{b}, for example, in a real-time market.

According to (29), the values of λ, q^{b}, as well as d^{c}, c∈ [symbol] at time interval τ, will have an impact on their values in future time intervals. Meanwhile, for a myopic LSE—one that concerns only with the profit for the current time interval, γ is set to 0, resulting in a static optimization that only concerns with the time interval t. If the LSE is farsighted, then γ>0. However, while all future time intervals can be taken into consideration here, decisions that concern any time interval beyond t, such as νₜ₊₁, will not be realized immediately. Once new information is revealed, the decisions concerning future intervals can be further improved.

Still referring to FIG. 4B, the LSE submits in the WEM a bid fₜ^{b} 410 that is characterized by a parameter vector ωₜ, then obtain a wholesale energy price λₜ and cleared energy purchase qₜ^{b}, and total cleared energy sales/purchases qₜ. All market participants determine their bids/offers based on the market clearing results in the previous time intervals, and the time-dependent bid response function, ψ(⋅), are defined using finite-order functions defined in Equation (5). In the meantime, the LSE may a finite-order price response function, denoted by ϕ(⋅), to characterize the collective behavior of all EUCs defined in Equation (6).

The objective of the joint bidding and pricing problem to be solved by the LSE is to determine the wholesale bid and the retail energy price, based on all available information. Before time interval t, the information related to the WEM that is available to the LSE includes ω_{τ}, λ_{τ}, q_{τ}, q_{τ}^{b}, ∀τ≤t−1. In the meantime, the information related to the REM that is available to the LSE includes ν_{τ}, d_{τ}, ∀τ≤t−1. Let [symbol] ₜ₋₁={ω_{τ}, λ_{τ}, q_{τ}, qₜ^{b}, ν_{τ}, d_{τ}, ∀τ≤t−1} denote the set of information available to the LSE before the WEM for time interval t is cleared. [symbol] ₜ₋₁ is referred to as the prior-WEM-clearing information set. In general, the retail energy price is posted to the EUCs 425 after the clearing of the WEM 420. This gives the LSE more information in addition to [symbol] ₜ₋₁, specifically, ωₜ, λₜ, qₜ, qₜ^{b}, when determining the retail energy price for time interval t. Define [symbol] ₜ₋₁= [symbol] ₜ₋₁∪{ωₜ, λₜ, qₜ, qₜ^{b}}, which is referred to as the post-WEM-clearing information set.

The bidding policy is defined as a vector function that maps [symbol] ₜ₋₁ to ωₜ and denoted by π(⋅), as follows:

ωₜ=π( [symbol] ₜ₋₁), (30)

in addition, the pricing policy is defined as a scalar function that maps [symbol] ₜ₋₁ to νₜ and denoted by μ(⋅), as follow:

νₜ=μ( [symbol] Jₜ₋₁), (31)

where μ return values in [ν, ν̅].

The joint bidding and pricing problem is next formulated as a Markov decision process (MDP). The MDP consists of a state space, an action space, a reward function, and a transition probability function that satisfies the Markov property, i.e., given the current state and action, the next state is independent of all states and actions in the past.

Specifically, define the state at time interval t to be sₜ=({ω_{τ}, λ_{τ}, q_{τ}, q_{τ}^{b}}ₜ₋ₙ_{₁}^{t-1}, {d_{τ}, ν_{τ}}ₜ₋ₙ_{₂}^{t-1}, t mod T), and the corresponding state space to be S=R^{5×n}^{₁}^{+2×n}^{₂}×T, where R is the set of real numbers. Define the action for time interval t to be aₜ={ωₜ, νₜ}, and the corresponding action space to be [symbol] =Ω×[ν, ν̅], where Ω is the set of feasible parameters for a bid, which is specified by the ISO. Given sₜ and at, sₜ₊₁, is determined through (5) and (6). Therefore, the Markov property is satisfied. However, the transition probability function is unknown since the explicit forms of ψ and ϕ are not known, nor are the transition probabilities of the random variables involved.

The action of the LSE consists of two components, ωₜ and νₜ, where νₜ is determined after ωₜ. As discussed earlier, at the time of determining νₜ, new information on the state is available and can be used to make more informed decisions. Define an intermediate state for time interval t as \tilde{s}ₜ=(ωₜ, λₜ, qₜ, qₜ^{b}, {ω_{τ}, λ_{τ}, q_{τ}^{b}}ₜ₋ₙ_{₁}^{t}, {d_{τ}, ν_{τ}}ₜ₋ₙ_{₂}^{t-1}, t mod T). Therefore, the bidding policy and the pricing policy can equivalently become

ωₜ=π(sₜ), (32)

νₜ=μ(\tilde{s}ₜ). (33)

At least one objective of the joint bidding and pricing problem is to maximize the profit of the LSE; therefore, define the reward for time interval t to be

rₜ=νₜdₜ−λₜqₜ^{q}−ϕₜ(dₜ−qₜ^{q}), (34)

which is the profit earned by the LSE for the time interval t. The cumulative discounted reward from time interval t and onwards, denoted by Rₜ and referred to as the return, is Rₜ=Σ_{τ=t}^{∞}γ^{τ-t}r_{τ}. The action value function under bidding policy π and pricing policy μ at action α and state s, denoted by Q^{π,μ}, (s, α), or equivalently, Q^{π,μ}(s, ω, ν), is the expected return defined as follows:

Q^{π,μ}(sₜ,aₜ)=Q^{π,μ}(sₜ,ωₜ,νₜ)= [symbol] [Rₜ|ₛ_{ₜ}_{,a}_{ₜ}_{;π,μ}]. (35)

Then, the joint bidding and pricing problem essentially becomes finding π and μ that maximize the following performance function:

J(π,μ)= [symbol] [R₁;π,μ]. (36)

The dynamical bid response and demand response models used for determining optimal joint bidding and pricing actions are represented by a linear function or a multi-layer feedforward neural network (FNN) explicitly; or a recurrent neural network (RNN) or a long short-term memory (LSTM) unit network implicitly. When learning the bid response function, the inputs are ({λ_{τ}, q_{τ}, qₜ^{b}}ₜ₋ₙ_{₁}^{t-1}, ωₜ, t mod T) and the outputs are (λₜ, qₜ, qₜ^{b}). When learning the price response function, the inputs are ({d_{τ}, ν_{τ}}ₜ₋ₙ_{₂}^{t-1}, t mod T) and νₜ, and the output is dₜ.

Then, the deep deterministic policy gradient (DDPG) based RL algorithm is used to solve the joint bidding and pricing problem through learning the bidding policy π and pricing policy μ.

Assume π and μ are parameterized by vectors θ^{π} and θ^{μ}. Then, finding optimal bidding and pricing policies is essentially finding optimal values for θ^{π} and θ^{μ}. The policy gradient methods are used to find (sub-optimal) values for θ^{π} and θ^{μ}, which update these parameters in the direction that maximizes J(π, —). For deterministic policies, the gradient of J can be computed using the Deterministic Policy Gradient Theorem. Deterministic polices typically outperform stochastic ones in terms of sample efficiency, and are more desired for control tasks. According to the Deterministic Policy Gradient Theorem, the gradient of J with respect to θ^{π} and θ^{μ}, referred to as the action gradients, are determined as follows:

∇_{θ}_{^{π}}J= [symbol] [∇_{ω}Q(s,π(s),μ(\tilde{s}))∇_{θ}_{^{π}}π(s)], (37)

∇_{θ}_{^{μ}}J= [symbol] [∇_{ν}Q(s,π(s),μ(\tilde{s}))∇_{θ}_{^{μ}}μ(s)], (38)

where \tilde{s} is the intermediate state after s following the policy π. Note that the gradient of the performance function J depends on the action value function Q, which is not known and needs to be estimated. The joint bidding and pricing problem is solved using the DDPG algorithm with an actor-critic architecture.

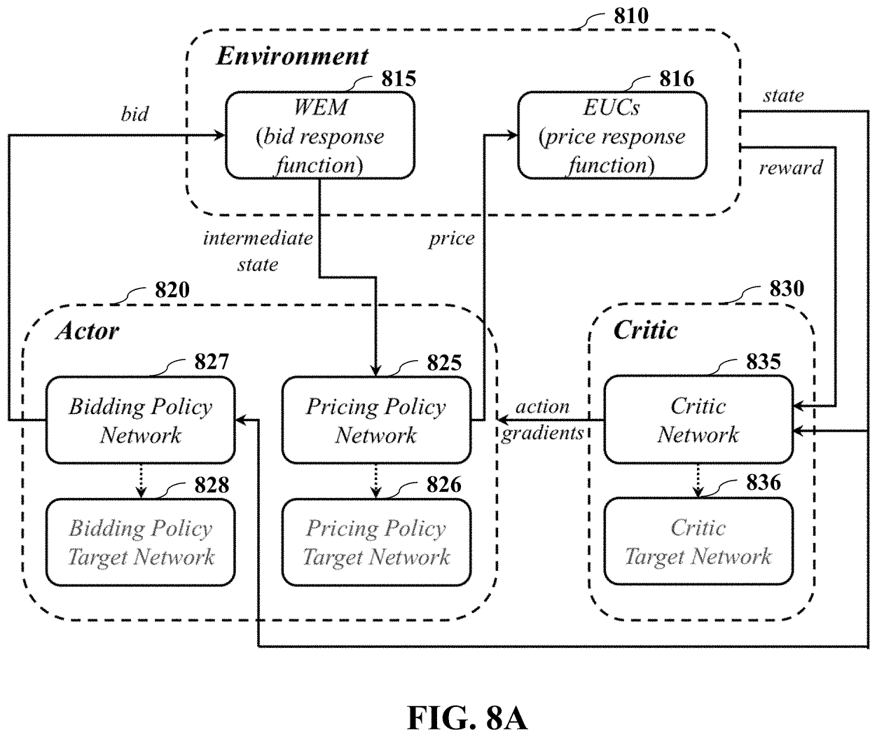

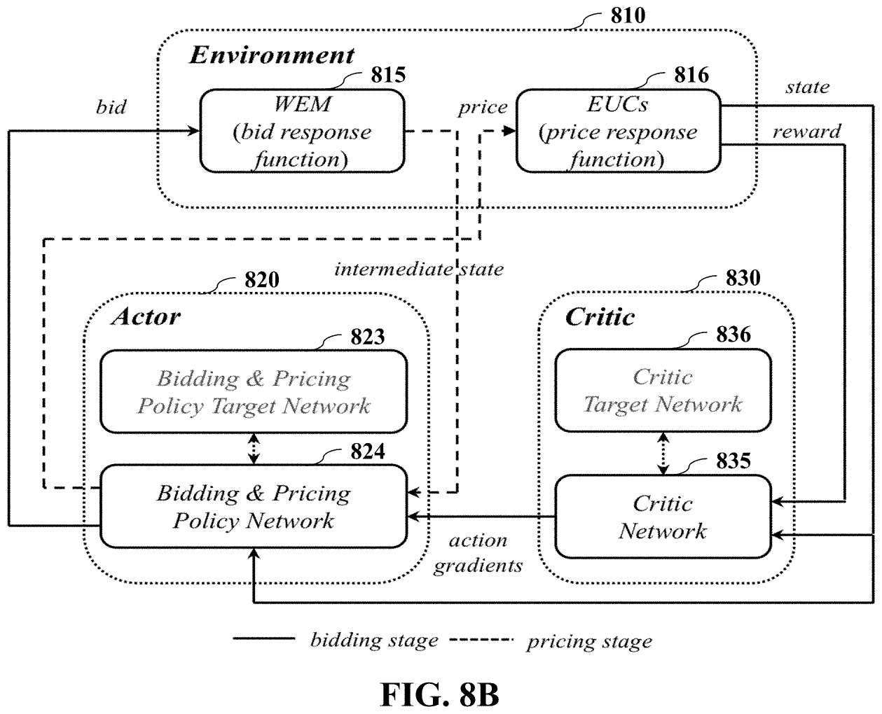

FIG. 8A is a diagram illustrating the actor-critic structure and interaction of components used in the joint bidding and pricing algorithm under asynchronized action mechanism, according to some embodiments of the present disclosure. For example, a critic 830 is used to estimate the action value function, and an actor 820 is used to estimate the policy, and neural networks are adopted to approximate these functions. Specific to the joint bidding and pricing problem, the action value function is represented by a neural network with a parameter vector θ^{Q}, referred to as the critic network 835. The parameters in the critic network can be estimated using methods such as temporal-difference learning. Meanwhile, the bidding policy and pricing policy are each represented by one neural network, referred to as the bidding policy network 827 and the pricing policy network 825, respectively, the weights of which are θ^{π} and θ^{μ}, respectively. The parameters in the bidding policy network and the pricing policy network, collectively referred to as the actor networks, can be estimated using the policy gradient method. In DDPG algorithm, target networks, the parameters of which slowly track those of the actor network and the critic network, are used to stabilize the algorithm. The parameter vector of the target network for the critic 836 is denoted by θ^{Q′}, and those of the bidding policy network and pricing policy network, 828 and 826 are denoted by θ^{π′} and θ^{μ′}, respectively. A replay buffer [symbol] is also used to store the transitions of the MDP and at each time instance, a mini-batch of size m is sampled from the [symbol] and used to estimate the gradients.

The detailed DDPG based RL algorithm for solving the joint bidding and pricing problem under asynchronized action mechanism is presented in Algorithm 2. At each step, θ^{Q} is updated in the direction that minimizes the following loss function, [symbol] :

$$𝓁 = \frac{1}{m} {\sum }_{i} {( {r}_{i} + γ {Q}^{′} ( {s}_{i + 1} , {π}^{′} ( {s}_{i + 1} ) , {μ}^{′} ( {\hat{\tilde{s}}}_{i + 1} ) ) - Q ( {s}_{i} , {a}_{i} ) )}^{2} . \qquad ( 39 )$$

Note that the target networks are used to compute the action value for the next time step. Also, an estimated value of \tilde{s}ᵢ₊₁, denoted by \tilde{ŝ}ᵢ₊₁, is used since the true intermediate state after \tilde{s}ᵢ following the bidding policy π′ is not known. \tilde{ŝ}ᵢ₊₁ is estimated using the trained/fitted bidding response function. Estimated values of the intermediate state are also used when evaluating the action gradients for the same reason.

Algorithm 2: Alternative DDPG-based Policy Learning Algorithm

Input: ψ, ϕ, α^{a}, α^{c}, M, m
Output: π, μ

| | |
|---|---|
| 1. | Randomly initialize critic network Q(s, a), bidding policy network π(s), and pricing policy network μ(s) with |
| | weights θ^{Q}, θ^{π} and θ^{μ}, respectively. |
| 2. | Initialize target networks Q′, π′ and μ′, with weights θ^{Q′} ← θ^{Q}, θ^{π′} ← θ^{π}, and θ^{μ′} ← θ^{μ} and respectively. |
| 3. | Initialize replay buffer [symbol] |
| 4. | for episode = 1, . . . , M do |
| 5. | Initialize two random process ζ and [symbol] for action exploration |
| 6. | Receive initial state s₀. |
| 7. | for τ = 0, . . . , T − 1 do |
| 8. | Select a wholesale bid with parameter ω_{τ} = π(s_{τ}) + ζ_{τ} |
| 9. | Submit the wholesale bid ω_{τ} in WEM, and observe WEM clearing results |
| | λ_{τ}, q_{τ} and q_{τ}^{b}, (λ_{τ}, q_{τ}, q_{τ}^{b}) = ψ({λₛ, qₛ, qₛ^{b}}_{τ-n}_{₁}^{τ-1}, ω_{τ}, τ mod T) |
| 10. | Select a retail energy price ν_{τ}, ν_{τ} = μ(\tilde{s}_{τ}) + [symbol] _{τ} |
| 11. | Post ν_{τ} in REM, and observe EUCs’ aggregate energy consumption d_{τ}, d_{τ} = ϕ({dₛ, υₛ}ₛ₋ₙ_{₂}^{s-1}, υ_{τ}, τ mod T) |
| 12. | Compute reward r_{τ}, r_{τ} = ν_{τ}d_{τ} − λ_{τ}q_{τ}^{q} − ϕ_{τ}(d_{τ} − q_{τ}^{q}), |
| 13. | Store transition (s_{τ}, a_{τ}, r_{τ}, s_{τ+1}) into [symbol] |
| 14. | Sample from [symbol] a mini-batch of m transitions (sᵢ, aᵢ, rᵢ, sᵢ₊₁) if \| [symbol] \| > m else continue |
| 15. | Compute estimated intermediate states [symbol] ᵢ |
| 16. | Update critic network by minimizing the loss [symbol] , |
| | $𝓁 = \frac{1}{m} {\sum }_{i} {( {r}_{i} + γ {Q}^{′} ( {s}_{i + 1} , {π}^{′} ( {s}_{i + 1} ) , {μ}^{′} ( {{s}^{\hat{\sim}}}_{i + 1} ) ) - Q ( {s}_{i} , {a}_{i} ) )}^{2} \text{:} {θ}^{Q} = {θ}^{Q} - {α}^{c} {∇}_{ {θ}^{Q}} 𝓁$ |
| 17. | Update bidding and pricing policy networks by maximizing J, J (π, μ) = [symbol] [R₁; π, μ] using sampled gradients, |
| | ${∇}_{ {θ}^{π}} J \approx \frac{1}{m} {\sum }_{i} {∇}_{ ω} Q ( {s}_{i + 1} , π ( {s}_{i + 1} ) , μ ( {{s}^{\hat{\sim}}}_{i + 1} ) ) {∇}_{ {θ}^{π}} π ( {s}_{i + 1} ) ,$ |
| | ${∇}_{ {θ}^{μ}} J \approx \frac{1}{m} {\sum }_{i} {∇}_{ v} Q ( {s}_{i + 1} , π ( {s}_{i + 1} ) , μ ( {{s}^{\hat{\sim}}}_{i + 1} ) ) {∇}_{ {θ}^{μ}} μ ( {{s}^{\hat{\sim}}}_{i + 1} ) \text{:}$ |
| | θ^{π} = θ^{π} + α^{a} ∇ _{θ}_{^{π}}J, |
| | θ^{μ} = θ^{μ} + α^{a} ∇ _{θ}_{^{μ}}J |
| 18. | Update target networks: |
| | θ^{Q′} ← ρθ^{Q} + (1 − ρ)θ^{Q′}, |
| | θ^{π′} ← ρθ^{π} + (1 − ρ)θ^{π′} |
| | θ^{μ′} ← ρθ^{μ} + (1 − ρ)θ^{μ′} |
| 19. | End for τ |
| 20. | End for episode |

The algorithm 2 is designed to determine pricing policy and bidding policy using separate neural networks according to FIG. 8A.

The computing wholesale bid is achieved in Step 8 as the output of the bidding policy function when the state collected from the environment are taken as the input. The biding policy function is represented by the bidding policy network which implemented as a neural network. The wholesale bid may include one or more pairs of bid prices and bid amounts, or a function to represent the relationship of bid price and bid amount. The wholesale bid price is also referred as “LSE offer amount” in this disclosure.

The computing retail energy price is achieved in Step 10 as the output of the pricing policy function when the state collected from the environment and the computed wholesale bid are available and taken as the input. The pricing policy function is represented by the pricing policy network, wherein the pricing policy network is implemented as a neural network as well.

The configurations or parameters of critic and actor networks, and critic and actor target networks are adaptively updated with latest information in Steps 11-18.

It is noted that only steps 8-18 are required for computing wholesale bids and retail energy prices for the upcoming time interval r and preparing for next time intervals, when it is used for real-time application. Meanwhile, the wholesale cleared results and the EUCs aggregate energy consumption used in Step 9 and Step 11 can be replaced with actual data if the actual measurements or information can be collected timely.

In addition, the neural network is represented by using a FNN when a finite number of previous time intervals is used, or a RNN or LSTM network when all available previous time intervals are used.

Similarly, the algorithm 2 can be easily extended to any variations to the DDPG structure. FIG. 8B is a diagram illustrating an alternative actor-critic structure and interaction of components used in the joint bidding and pricing algorithm under asynchronized action mechanism, according to some embodiments of the present disclosure. For example, the bidding and pricing policy can also be collectively determined, wherein a composite bidding and pricing policy network 824, and associated a composite bidding and pricing target policy network 823 are used to produce bidding and pricing actions jointly.

Exemplar Simulation

The application of the disclosed joint bidding and pricing algorithm can be illustrated through numerical simulations under synchronized WEM and REM action mechanism, in which the multi-layer feedforward neural networks are used to represent the bid and price response functions, and bidding and pricing policy networks.

The WEM model is constructed based on a 300-bus test system, which has 69 generators, each corresponding to one seller, and 195 loads, each corresponding to one buyer. For an illustrative purpose, assume each offer/bid is a pair of offer/bid price (in $/MWh) and quantity (in MW). Then, the wholesale bid ωₜ is a two-dimensional vector that consists of a bid price and a bid quantity. The offer quantities of the sellers are taken from the generator capacities in the test system, and the offer prices are sampled uniformly from [10, 30] $/MWh. The bid quantities of the buyers are taken from historical loads of a practical system, with their peak values scaled to the nominal loads in the test case, and the bid prices are sampled uniformly from [20, 40] $/MWh. In addition, an inelastic load, the peak value of which equals to 50% of the total generator capacity, is also added. System losses and line congestions are ignored in the WEM clearing problem, and only generation capacity limits are considered. Assume the LSE under study serves 100 EUCs. The backlog rate ηₜ^{c} is sampled uniformly from [0, 0.5]. The newly generated incremental energy need ξₜ^{c} is simulated using historical incremental loads from the practical system scaled by a value that is sampled uniformly from [0.1, 2] MW, and added with a zero-mean Gaussian noise that has a scaled standard deviation of 0.1. The benefit function takes the following quadratic form:

β^{c}(eₜ^{c},dₜ^{c})=κₜ^{c}(eₜ^{c}−dₜ^{c})²+ζₜ^{c}dₜ^{c},

where κₜ^{c} (in $/MWh²) is sampled from a Gaussian distribution with a mean of 10 and a standard deviation of 1, and ζₜ^{c} is sampled uniformly from [20, 30] $/MWh. The feasible set of the energy consumption is [symbol] ={dₜ^{c}≥0}.

Other parameters are set as follows: T=24, i.e., one day is decomposed into 24 segments, and ϕₜ(x)=5|x|, i.e., the LSE will loss $5 if the aggregate energy consumption in the REM deviates from purchased energy quantity in the WEM by 1 MW. We create two scenarios, a winter scenario in which historical load data from the practical system during 3 months in winter are used, and a summer scenario in which historical load data from the practical system during 3 months in summer are used. In both scenarios, data from the first two months are used for training, while data for the last month are used for testing.

The response functions are critical since they replace the actual environment during the learning process of the bidding and pricing policy, and also are used to determine the state in the MDP formulation. The response functions are represented using neural networks, and the parameters of are learned using the backpropagation algorithm. To illustrate the application of the response functions, we first generate a set of historical data of the WEM, i.e., {ω_{τ}, λ_{τ}, q_{τ}}, using the WEM model in (1), and a set of historical data of the REM, i.e., {ν_{τ}, d_{τ}} using the EUC model in (4). When generating the data of the WEM, the bid quantities from the LSE under study are sampled uniformly from [0, 80] MW, and the bid prices are sampled uniformly from [20, 40] $/MWh.

A neural network with 2 hidden layers, each consisting of 128 neurons are used as the bid response function. An L2 regularizer with a scale of 0.01 is used. Rectified linear unit (ReLU) is used as the activation function for the two hidden layers and the output layer. Adam optimizer with a learning rate of 0.001 is adopted to train the neural network for 10000 steps. The performance of the response functions is measured by the mean and standard deviation of the absolute error between the actual and predicted responses. Table I shows the mean and standard deviation of the absolute error in the wholesale energy price under different orders of the bid response function. The mean wholesale energy prices of the training data in the winter scenario and the summer scenario are 22.98 $/MWh and 23.72 $/MWh, respectively, and those of the testing data in the winter scenario and the summer scenario are 22.63 $/MWh and 23.40 $/MWh, respectively. Note that a zero-order bid response function takes only information on the time as well as the bid when predicting the WEM clearing results. Both the mean and standard deviation of the absolute error decrease as the order of the response function increases. Yet, the decrease is not significant when the order is great than 1 in both scenarios. Therefore, an appropriate order of the bid response function for this case would be n₁=1.

The neural network adopted for the price-based demand response function is similar to that for the bid response function except that the number of neurons in each hidden layer is 256 and the scale of the L2 regularizer is 0.001. The neural network is trained with a learning rate of 0.0002 for 20000 steps. Table II shows the mean and standard deviation of the absolute error in the aggregate energy consumption under different orders of the price response function. The mean aggregate energy consumptions in the training data in the winter and summer scenarios are 40.75 MW and 50.45 MW, respectively, and those of the testing data in the winter and summer scenarios are 38.16 MW and 47.08 MW, respectively. A zero-order price response function takes only information on the time and the price when predicting the aggregate energy consumption. Similar to the argument made for the bid response function, an appropriate order for the price response function would be n₂=1.

TABLE I
Absolute Error in Wholesale Energy Price (in $/MWh)

| | | winter scenario | | | summer scenario | | |
|---|---|---|---|---|---|---|---|
| order | | 0 | 1 | 2 | 0 | 1 | 2 |
| Train | Mean | 0.82 | 0.27 | 0.26 | 1.02 | 0.26 | 0.26 |
| | Standard | 0.77 | 0.23 | 0.21 | 0.73 | 0.18 | 0.18 |
| | Deviation | | | | | | |
| Test | Mean | 0.82 | 0.26 | 0.23 | 1.03 | 0.25 | 0.25 |
| | Standard | 0.64 | 0.22 | 0.20 | 0.69 | 0.18 | 0.18 |
| | Deviation | | | | | | |

TABLE II
Absolute Error in Aggregate Energy Consumption (in MW)

| | | winter scenario | | | | summer scenario | | | |
|---|---|---|---|---|---|---|---|---|---|
| order | | 0 | 1 | 2 | 3 | 0 | 1 | 2 | 3 |
| train | Mean | 6.24 | 3.15 | 1.40 | 1.31 | 8.40 | 3.66 | 1.45 | 1.41 |
| | Stan- | 5.21 | 2.41 | 1.40 | 1.32 | 6.22 | 2.62 | 1.20 | 1.16 |
| | dard | | | | | | | | |
| | Devi- | | | | | | | | |
| | ation | | | | | | | | |
| test | Mean | 6.27 | 3.21 | 1.43 | 1.43 | 8.07 | 3.61 | 1.51 | 1.48 |
| | Stan- | 4.78 | 2.33 | 1.23 | 1.22 | 6.03 | 2.57 | 1.26 | 1.20 |
| | dard | | | | | | | | |
| | Devi- | | | | | | | | |
| | ation | | | | | | | | |

We emphasize that the appropriate order of response functions may vary from case to case, and need to be determined from the historical data following the procedures presented here. Based on learned response function, the state is sₜ=(λₜ₋₁, qₜ₋₁, dₜ₋₂, νₜ₋₂, dₜ₋₁, νₜ₋₁, t mod T).

The pricing policy network and the critic network each has 2 hidden layers each with 128 neurons. ReLU is used as the activation function for all hidden layers. The output layer of the pricing policy network adopts the tanh function as the activation function, while that of the critic network does not use any activation function. An L2 regularizer with a scale of 0.01 is used for the critic network. The learning rates for the pricing policy network and the critic network are 0.0001 and 0.001, respectively. Note that the bidding policy network essentially the bid price to the retail energy price and the bid quantity to the estimated aggregate energy consumption obtained using the price response function. Therefore, there is no parameter for the bidding part needs to be trained. The minimum price is 20 $/MWh and the maximum price is 40 $/MWh. The update rate for the target networks is 0.001. The size of a mini-batch is chosen to be 64. The discount rate is 0.9. The policy is trained over 200 episodes.

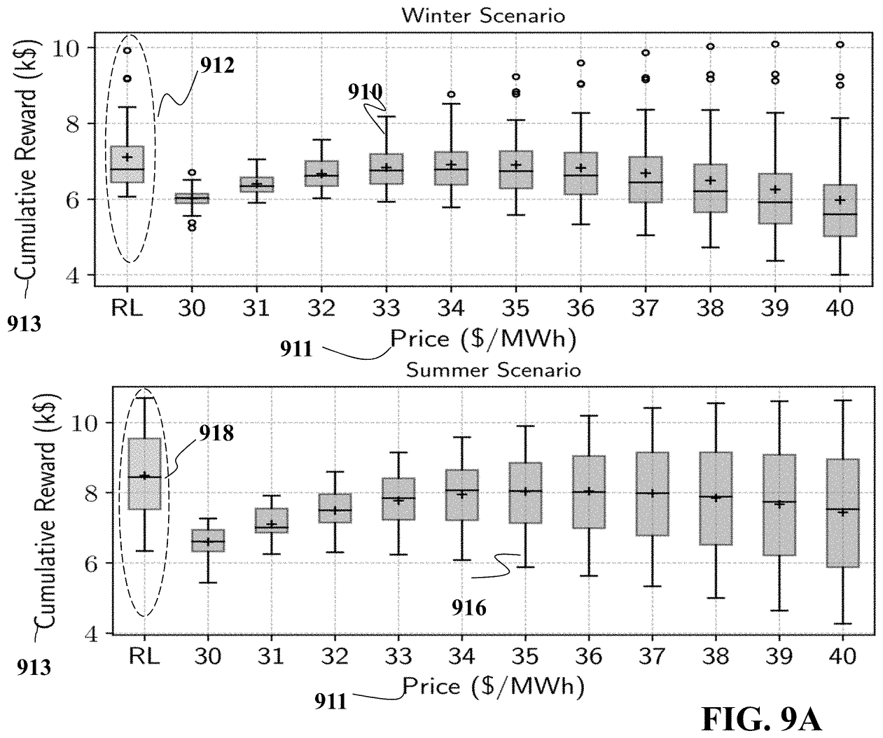

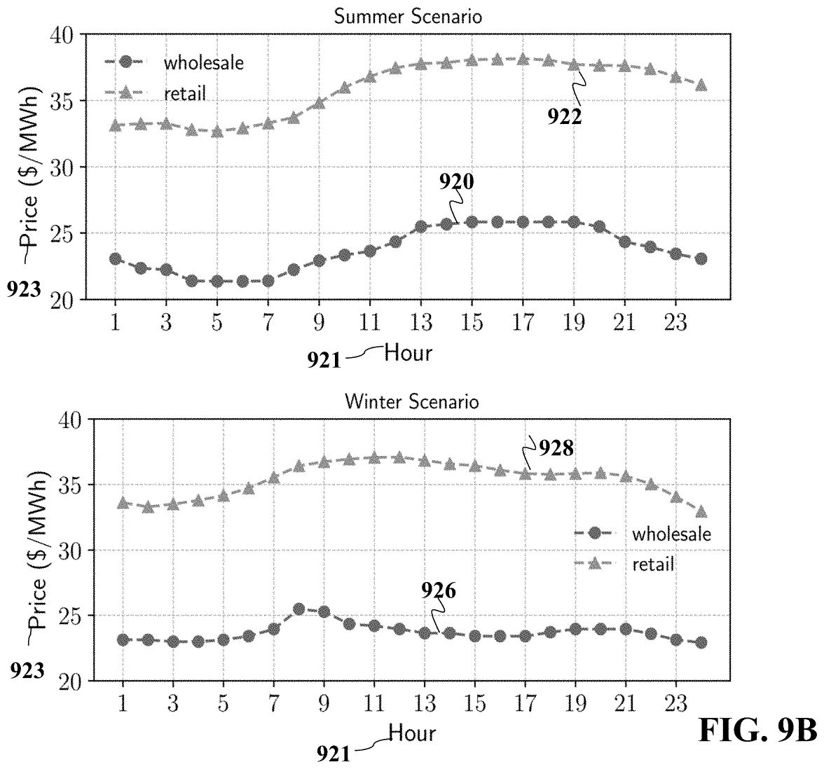

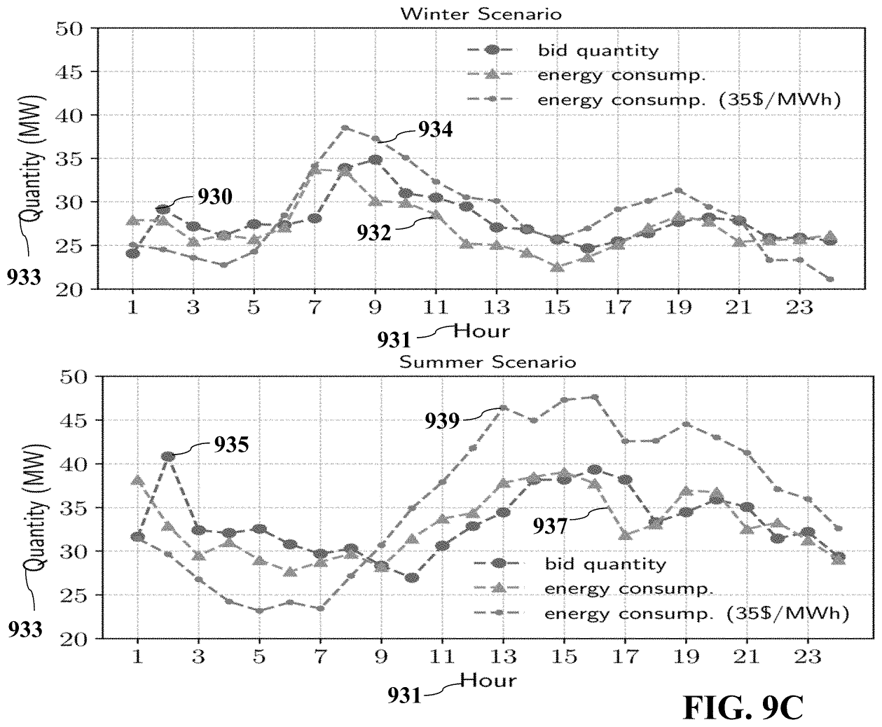

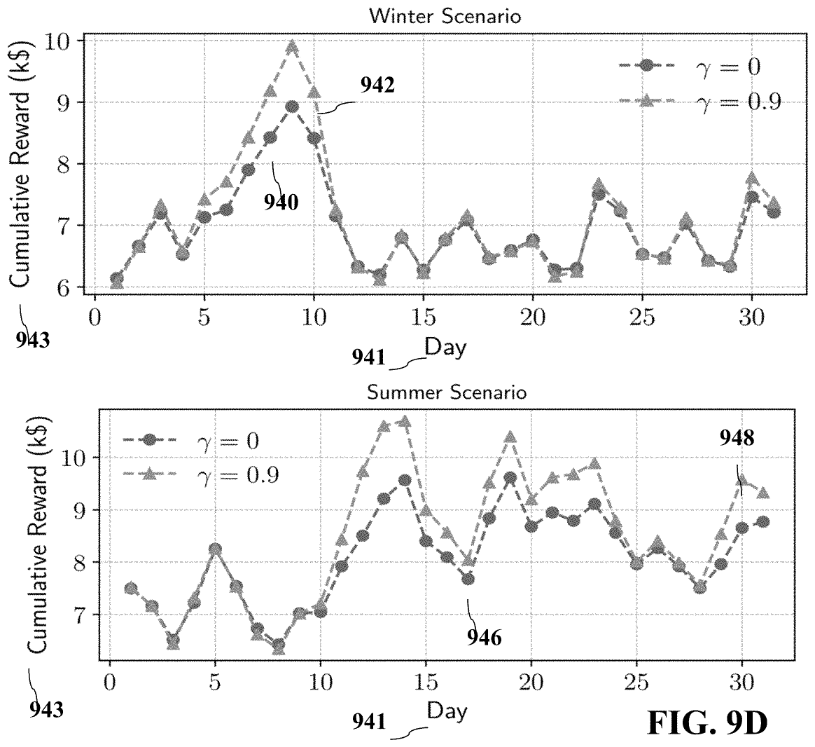

The test results are given in FIGS. 9A, 9B, 9C and 9D. During the testing, we benchmark the disclosed methodology with a baseline bidding and pricing policy which sets the retail energy price to a constant, and submits a bid price that equals to the retail energy price and a bid quantity that equals to the estimated aggregate energy consumption obtained using the price response function.

FIG. 9A is a diagram illustrating the cumulative rewards under baseline policies and RL policy, according to some embodiments of the present disclosure. The horizontal axis 911 of FIG. 9A represents the energy price, and the vertical axis 913 of FIG. 9A represents the cumulative rewards. The plots 912 and 918, 910 and 916 represent the rewards for baseline polices and RL polices in winter and summer seasons, respectively. FIG. 9A presents a box-plot of the cumulative rewards—the sum of immediate rewards during a day-under the policy learned by the DDPG algorithm—referred to as the RL policy—and the baseline policies with various constant prices. The mean cumulative reward under the RL policy is higher than those under baseline policies in both two scenarios. Specifically, the mean cumulative reward under the RL policy in the winter scenario and the summer scenario are 7.111 k$ and 8.485 k$, respectively, while the highest mean cumulative reward under the baseline policies are 6.914 k$ and 8.041 k$, respectively.

The wholesale and retail energy prices under RL policy during a typical day are shown in FIG. 9B, while the bid quantities and the aggregate energy consumptions during the same day is presented in FIG. 9C. We also plot the aggregate energy consumptions under the baseline policy with a constant price of 35 $/MWh in FIG. 9C.

FIG. 9B is a diagram illustrating the wholesale and retail energy prices under RL policy during a typical day, according to some embodiments of the present disclosure. For example, the horizontal axis 921 of FIG. 9B represents the hour of the day, and the vertical axis 923 of FIG. 9B represents the energy price for WEM or REM. The curves 920 and 926, 922 and 928 represent the prices for WEM and REM under winter and summer scenarios, respectively

FIG. 9C is a diagram illustrating the bid quantities and aggregate energy consumptions during a typical day, according to some embodiments of the present disclosure. For example, the horizontal axis 931 of FIG. 9C represents the hour of the day, and the vertical axis 933 of FIG. 9C represents the energy quantity. The curves 930 and 935, 932 and 937, 934 and 939 represent the bid quantities, the energy consumptions using RL polices and the energy consumptions using fixed price polices under winter and summer scenarios, respectively.

Referring to FIG. 9B and FIG. 9C, we make two observations here. First, the optimal retail energy price has a similar trend as the wholesale energy price. This makes sense since the cumulative reward depends on the difference of these two prices. Second, the aggregate energy consumptions under the RL policy has lower variance than under the baseline policy, which results into a smoother load curve. These phenomena are also observed in most of the other days.

As discussed earlier, the consideration of the long-term behavior is beneficial, compared to the myopic decision making, in which no future rewards are taken into account. To illustrate this, we compare the cumulative rewards under the RL policy with γ=0.9 and those under a myopic policy, or equivalently, the RL policy with γ=0.

FIG. 9D is a diagram illustrating the impacts of discount factor on cumulative rewards, according to some embodiments of the present disclosure. For example, FIG. 9D shows the impacts of discount factor on cumulative rewards, wherein horizontal axis 941 of FIG. 9D represents the day of the month, and the vertical axis 943 of FIG. 9D represents the cumulative rewards. The curves 940 and 946, 942 and 948 represent the cumulative rewards for myopic and long-term strategy under winter and summer scenarios, respectively.

As shown in FIG. 9D, the RL policy with γ=0.9 outperforms the myopic policy in both two scenarios. This indeed justifies the motivation of modeling the joint bidding and pricing problem as an MDP.

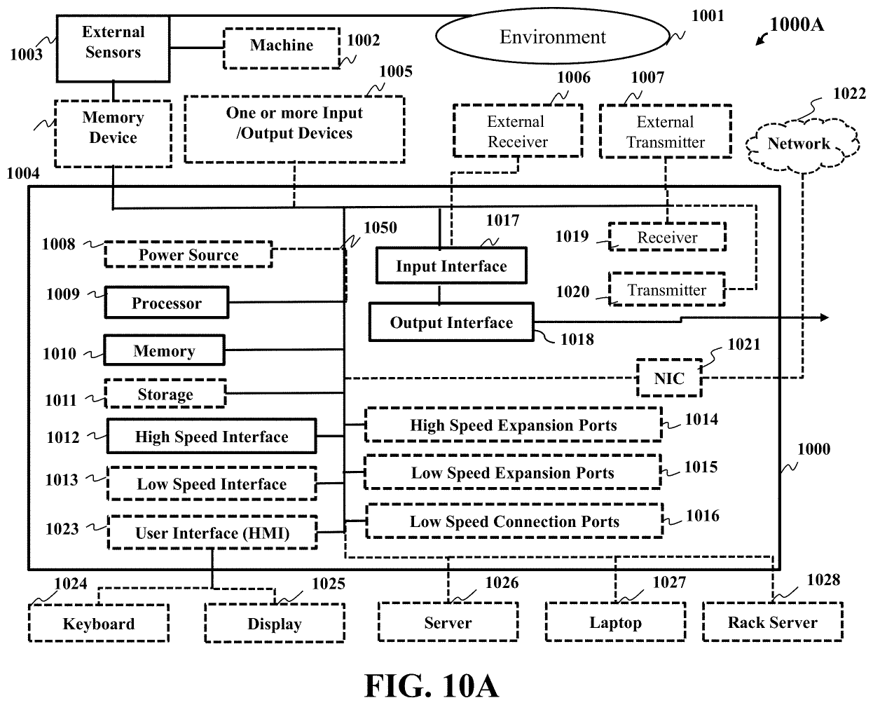

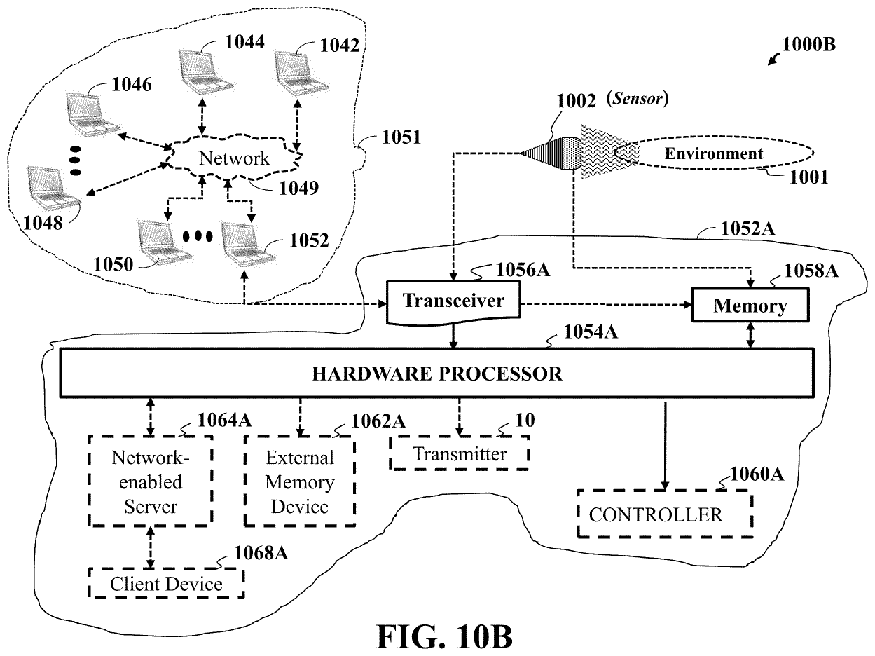

FIG. 10A is a schematic illustrating by non-limiting example a computing apparatus 1000A that can be used to implement some techniques of the methods and systems, according to embodiments of the present disclosure. The computing apparatus or device 1000A represents various forms of digital computers, such as laptops, desktops, workstations, personal digital assistants, servers, blade servers, mainframes, and other appropriate computers.

The computing device 1000A can include a power source 1008, a processor 1009, a memory 1010, a storage device 1011, all connected to a bus 1050. Further, a high-speed interface 1012, a low-speed interface 1013, high-speed expansion ports 1014 and low speed connection ports 1015, can be connected to the bus 1050. Also, a low-speed expansion port 1016 is in connection with the bus 1050. Contemplated are various component configurations that may be mounted on a common motherboard, by non-limiting example, 1030, depending upon the specific application. Further still, an input interface 1017 can be connected via bus 1050 to an external receiver 1006 and an output interface 1018. A receiver 1019 can be connected to an external transmitter 1007 and a transmitter 1020 via the bus 1050. Also connected to the bus 1050 can be an external memory 1004, external sensors 1003, machine(s) 1002 and an environment 1001. Further, one or more external input/output devices 1005 can be connected to the bus 1050. A network interface controller (NIC) 1021 can be adapted to connect through the bus 1050 to a network 1022, wherein data or other data, among other things, can be rendered on a third-party display device, third party imaging device, and/or third-party printing device outside of the computer device 1000A.

Contemplated is that the memory 1010 can store instructions that are executable by the computer device 1000A, historical data, and any data that can be utilized by the methods and systems of the present disclosure. The memory 1010 can include random access memory (RAM), read only memory (ROM), flash memory, or any other suitable memory systems. The memory 1010 can be a volatile memory unit or units, and/or a non-volatile memory unit or units. The memory 1010 may also be another form of computer-readable medium, such as a magnetic or optical disk.

Still referring to FIG. 10A, a storage device 1011 can be adapted to store supplementary data and/or software modules used by the computer device 1000A. For example, the storage device 1011 can store historical data and other related data as mentioned above regarding the present disclosure. Additionally, or alternatively, the storage device 1011 can store historical data similar to data as mentioned above regarding the present disclosure. The storage device 1011 can include a hard drive, an optical drive, a thumb-drive, an array of drives, or any combinations thereof. Further, the storage device 1011 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 1009), perform one or more methods, such as those described above.

The system can be linked through the bus 1050 optionally to a display interface or user Interface (HMI) 1023 adapted to connect the system to a display device 1025 and keyboard 1024, wherein the display device 1025 can include a computer monitor, camera, television, projector, or mobile device, among others.

Still referring to FIG. 10A, the computer device 1000A can include a user input interface 1017 adapted to a printer interface (not shown) can also be connected through bus 1050 and adapted to connect to a printing device (not shown), wherein the printing device can include a liquid inkjet printer, solid ink printer, large-scale commercial printer, thermal printer, UV printer, or dye-sublimation printer, among others.

The high-speed interface 1012 manages bandwidth-intensive operations for the computing device 1000A, while the low-speed interface 1013 manages lower bandwidth-intensive operations. Such allocation of functions is an example only. In some implementations, the high-speed interface 1012 can be coupled to the memory 1010, a user interface (HMI) 1023, and to a keyboard 1024 and display 1025 (e.g., through a graphics processor or accelerator), and to the high-speed expansion ports 1014, which may accept various expansion cards (not shown) via bus 1050. In the implementation, the low-speed interface 1813 is coupled to the storage device 1011 and the low-speed expansion port 1015, via bus 1050. The low-speed expansion port 1015, which may include various communication ports (e.g., USB, Bluetooth, Ethernet, wireless Ethernet) may be coupled to one or more input/output devices 1005, and other devices a keyboard 1024, a pointing device (not shown), a scanner (not shown), or a networking device such as a switch or router, e.g., through a network adapter.

Still referring to FIG. 10A, the computing device 1000A may be implemented in a number of different forms, as shown in the figure. For example, it may be implemented as a standard server 1026, or multiple times in a group of such servers. In addition, it may be implemented in a personal computer such as a laptop computer 1027. It may also be implemented as part of a rack server system 1028. Alternatively, components from the computing device 1000A may be combined with other components in a mobile device, such as a mobile computing device. Each of such devices may contain one or more of the computing device 1000A and the mobile computing device, and an entire system may be made up of multiple computing devices communicating with each other.

FIG. 10B is a block diagram illustrating some computing devices that can be used for implementing the systems and methods that includes a network overview, according to embodiments of the present disclosure. An example of a network for implementing a local resource allocation market (LRAM) 1051 can include a central computer 1042, i.e. may be more than one central computer and a network 1049 communicatively connected to networked computers 1044, 1046, 1048, 1050 and 1052. The central computer 1042 can manage and operate the LRAM 1051, and by non-limiting example, be associated with an operator that manages an electric power system that serves or is served by electrical loads or resources associated with the networked computers 1044, 1046, 1048, 1050 and 1052. The central computer 1042 can be associated with one or more buses in an electric power system, one or more types of substations. Also, the network 1049 may by non-limiting example include computing hardware connected with an electrical device, a power generator, etc., wherein the computing hardware may include integrated circuits that are structured to perform the systems and method of the present disclosure. The central computer 1042 can receive bids or requests from those computing devices associated with end-use consumers (EUC) which can be computing devices 1046, 1048, and receive offers from those computing devices associated with power producers/suppliers which can be computing devices 1044, 1050 and 1052. The operator or central computer 1042 can then compute a value at which the electricity is to be sent, and transmit the sent value to the computing devices 1044, 1046, 1048, 1050 and 1052. When the sent value refers to an actual price of the electricity, i.e. “clearing price”, of the current time interval or of the next upcoming time interval. Noted is that the time intervals can vary, for example, 30 minutes, 15 minutes, at 10-minute periods or 5-minute periods. The central computer 1042 can be used by the computing devices 1044, 1046, 1048, 1050 and 1052 to compute a demand bid or supply offer. The central computer 1042 can also have other data such as future market data that can be transmitted to the networked computers. Further, the central computer 1042 can be accessed over the network 1049, which can be used as a Local Area Network (“LAN”) using wired networking (e.g., the Ethernet IEEE standard 802.3 or other appropriate standard) or wireless networking.

For example, as noted above, the end-use consumers (EUC) can use computing devices 1046, 1048, to request electricity from their load serving entity (LSE) based on their current electricity needs, i.e. electricity to power electrical devices. The computing devices 1046, 1048, can be transactive controllers or active controllers, which can be used to request the electricity from the LSE, i.e. transactive controllers are capable of transmitting bids to the LSE, whereas the active controllers are used to control equipment not capable of computing and transmitting bids to the LSE, but can be help from adaptive control strategies. The EUC inputs their amount of electricity needed, for example, through a web site that transmits the EUC's requests over the Internet to the central computer 1042 used by a load serving entity (LSE) to allocate the electricity. In such instances, the requests can be computed and transmitted by executing computer-executable instructions stored in non-transitory computer-readable media (e.g., memory or storage). The electricity requests include a quantity of the electricity needed and a requested price. It is possible that the central computer 1042 can receive electricity bids from those computing devices associated with EUC's 1046, 1048, and receive electricity offers from those computing devices associated with electricity/power via computing devices 1044, 1050 and 1052.

Still referring to FIG. 10B, 1000B includes a computing device 1052A (which is computing device 1052, which can be a controller such as a transactive controller or active controller), that includes a hardware processor 1054A, in communication with a transceiver 1056A. The transceiver 1056A can be in communication with a sensor 1002 or sensors, that collects data from an environment 1001 that is related to an area the electrical device operates. The sensor 1002 converts an input into a signal, which can be stored in memory 1058A. The hardware processor 1054A in communication with a computer storage memory, i.e. memory 1058A, such that the memory 1058A includes stored data, including algorithms, instructions and other data, that can be implemented by the hardware processor 1054A. The computing device 1052A can further include a controller 1060A, external memory device 1062A, network-enabled server 1064A and a client device 1068A.

It is contemplated the hardware processor 1054A can include two or more hardware processors depending upon the requirements of the specific application, wherein the processors can be either internal or external. Certainly, other components may be incorporated with method 1000B including output interfaces and transceivers, among other devices.

It is possible the network 1049 can include, by non-limiting example, one or more local area networks (LANs) and/or wide area networks (WANs). Wherein the networking environments can be similar to enterprise-wide computer networks, intranets and the Internet. Contemplated for all the components mentioned that there can be any number of client devices, storage components, and data sources employed within the system 1000B. Each may comprise a single device or multiple devices cooperating in a distributed environment. Further, system 1000B can include one or more data source(s) (not shown). The data source(s) can comprise data resources for training neural networks to express bid and price response functions. The data provided by data source(s) may include historical wholesale bids and cleared prices and quantities, and historical retail energy prices and aggregate energy consumptions.

The present disclosure improves the existing technology and technological field, for example the fields of electrical power grid management and electrical device control using the transactive controllers. For example, the computing hardware is activating and deactivating the electrical device based on the comparison of the submitted offer amount to the retail price. Specifically, that the components of the systems and methods of the present disclosure are meaningfully applied to improve the control of end-use electrical devices using the transactive computing devices associated with the electrical devices, which in turn, improves the electrical power grid management. Further, the steps of the systems and methods of the present disclosure are by computing hardware associated with the electrical device.

Features

According to aspects of the present disclosure, the user selected desired operating level can be selected from a first user desired operating level and a second user desired operating level, wherein the second user desired operating level is representative of the user choosing to pay more value to attain a desired operation level for the electrical device compared to the first desired operating level.

Another aspect of the present disclosure can include the LRAM is a wholesale electricity market (WEM) operated by an independent system operator (ISO), and the user selected desired operating level of the user, is an end use customer (EUC) consumer of the electricity in the REM, wherein the offer amount and the retail price are utilized by a load serving entity (LSE). Further, an aspect can be that the LRAM is a real-time electricity market or a day-ahead electricity market.

Another aspect of the present disclosure can include the electrical device is one of an air-conditioning unit, heating unit, hot water heater, refrigerator, dish washer, washing machine, dryer, oven, microwave oven, pump, home lighting system, electric vehicle charger, one or more commercial electrical system or home electrical system. Further, an aspect can include that the current environmental data includes environmental data for the user location, as well as forecasted environmental data for the user location for the upcoming time interval.

It is possible that an aspect can be that the stored historical energy futures market data includes past energy futures market information and past LRAM information, and wherein the computing of the offer amount is performed based at least in part on offer amount information from the past energy futures market information, and at least in part on offer amount information from the past LRAM. Wherein the offer amount information from the electricity futures market information comprises offer information from a fixed window of time from a real-time electricity market, and wherein the offer amount information from the LRAM information comprises offer amount information for a rolling window of time.

Another aspect can include the offer amount and the retail price are utilized by a load serving entity (LSE), and computed jointly by maximizing LSE expectation of future profits starting from the upcoming time interval, subject to at least one energy balance constraint, and a future profit of the upcoming time interval determined based on a difference between the retail price and the cleared LRAM price, and an amount of electricity consumed by the user for the upcoming time interval and a cleared quantity of electricity corresponding with the cleared price for electricity from the LRAM. It is possible an aspect can include the amount of electricity consumed by the user is a dynamical demand response function of retail prices, and amounts of electricity consumed by the user at time intervals prior to the upcoming time interval, and the computed retail price for the upcoming time interval. Further, an aspect can be that the dynamical demand response function is learned using a supervised learning approach by a multi-layer feedforward neural network when a finite number of previous time intervals are used, or a recurrent neural network (RNN) or a long short-term memory (LSTM) unit network, when all available previous time intervals are used.

It is possible an aspect can include the cleared price and the cleared quantity of electricity for electricity from the LRAM is a dynamical bid response function of the cleared prices and quantities for electricity by the LRAM at time intervals prior to the upcoming time interval, and the offer amount to the LRAM for the upcoming time interval. Wherein the dynamical bid response function is learned using a supervised learning approach by a multi-layer feedforward neural network, when a finite number of previous time intervals is used, or a recurrent neural network (RNN) or a long short-term memory (LSTM) unit network, when all available previous time intervals are used.

Further, another aspect can be that the offer amount and the retail price of a load serving entity (LSE) is determined jointly, the retail price is first computed using a pricing policy based on previous state information, and the offer amount is then computed using a bidding policy based on previous state information, and the computed retail price; wherein the previous state information includes LSE offer amounts, LRAM cleared prices and quantities, amounts of electricity consumed by the user, and retail prices for all time intervals prior to the upcoming time interval.

Another aspect can include that the offer amount and the retail price of a load serving entity (LSE) is determined jointly, the offer amount is computed using a bidding policy based on previous state information, and the retail price is computed using a pricing policy based on previous state information, the offer amount, and the cleared price and quantity; wherein the previous state information includes LSE offer amount, LRAM cleared prices and quantities, amounts of electricity consumed by the user, and retail prices for all time intervals prior to the upcoming time interval.

Another aspect can include that the retail price of a load serving entity (LSE) is computed by a pricing policy based on current state information, where the state information includes past individualized user selected desired operating levels by the user at past corresponding time intervals to the upcoming time interval, and past individualized LSE retail pricing data for electricity in a retail electricity market (REM) at past corresponding time intervals to the upcoming time interval, and past cleared pricing data for electricity from the LRAM at past corresponding time intervals to the upcoming time interval.

It is possible an aspect can include that the computation of the offer amount and the retail price are computed jointly by formulating a Markov decision process, and solved using deep deterministic policy gradients approach with an actor-critic structure, wherein an actor is implemented by neural networks to determine a candidate of an offer amount and a retail price, and a critic is implemented by neural networks to evaluate a performance of the candidate offer amount and the candidate retail price, to adjust the parameters of neural networks, for improving performance. Wherein the actor includes a pricing policy network, a bidding policy network, and a pricing policy target network, and the critic includes a critic network, and a critic target network, wherein the pricing policy network is first used to compute a retail price, then the bidding policy network is used to compute an offer amount with the computed retail price to improve the overall profit earned by the LSE.

Further still, wherein the actor includes a pricing policy network, a bidding policy network, a pricing policy target network, and a bidding policy target network, and the critic includes a critic network, and a critic target network; wherein the bidding policy network is first used to compute an offer amount, then the pricing policy network is used to compute an retail price with the cleared prices and quantities from the LRAM corresponding to the computed off amount, to improve the overall profit earned by the LSE.

An aspect can include computing the offer amount is based on multiple factors for the upcoming time interval, including the user selected desired operating level, the current environmental data, and the stored historical energy futures market data used to determine inter-temporal correlation behaviors of past offer amounts to a local resource allocation market (LRAM) and the past clearing pricing for electricity by the LRAM, to obtain the offer amount.

### Definitions

Processor, by non-limiting example, as stated in claim 1 can be computer hardware, i.e. a logic circuitry that responds to and processes the basic instructions that drive a computer to implement the algorithm described in present disclosure.

User selected desired operating level of an electrical device, includes, by non-limiting example, a user deciding upon an operating level, i.e. an amount of electricity according to the user desire sensed feeling such as to a cold feeling or a hot feeling. Wherein the user changes an operation of a device, such as a heater device or the like, cooling device or the like, or both, to a user desired operating level according to the user's specific desire in accordance with temperature, humidity and the like. According to the retail energy price changes, the user may change the operating level accordingly to maximize the benefit. The operating level for the upcoming time interval can be determined using the price response function with given retail energy price for the upcoming time interval.

Upcoming time interval is a time interval in the future as opposed to a current time interval, which is at the current moment in time, or to a past time interval which is a time before the current time interval.

Computing an offer amount refers to determining a representative of a value, i.e. price, at which electricity is available to be supplied to operate an electrical device for an upcoming time interval at a user selected desired operating level, i.e. an amount of electricity. The offer amount is included in the wholesale bid as a bid price along with a bid quantity, i.e. the user selected desired operating level in the Specification. By non-limiting example, the computing an offer amount can be found in Section headings of the Specification labeled “computing wholesale bid”, however, some Sections may not be labeled. The computing an offer amount is jointly implemented with the computing a retail price within the deep reinforcement learning process as described in Algorithm 1, or in the algorithm 2, according to different synchronization mechanism is used between the wholesale market actions and the retail market actions.

During the real-time application, when the synchronized action mechanism is used between the wholesale market and the retail market, the computing an offer amount and computing a retail price for the upcoming time interval is achieved through the following consecutive steps:
1. Train or update the pricing policy, bidding policy and critic networks, and the pricing policy and critic target networks using DDPG algorithm, and historical data prior to the upcoming time interval.
2. Receive the state from the environment, including offer amounts, cleared wholesale prices and quantities, retail energy prices, and user selected desired operating level corresponding to retail energy prices prior to the upcoming time interval.
3. Compute the retail energy price by setting the price using the output of the pricing policy function when the state collected from the environment are taken as the inputs. The pricing policy function is represented by the pricing policy network, wherein the pricing policy network is implemented as a neural network.
4. Compute the offer amount by setting the offer amount using the output of the bidding policy function when the computed retail energy price, and the state collected from the environment are taken as the inputs. The biding policy function is represented by the bidding policy network which implemented as a neural network.

Similarly, when the asynchronized action mechanism is used between wholesale market and retail market, the computing an offer amount and computing a retail price for the upcoming time interval is achieved using the following consecutive steps:
1. Train or update the pricing policy, bidding policy and critic networks, and the pricing policy, bidding policy, and critic target networks using DDPG algorithm, and historical data prior to the upcoming time interval.
2. Receive the state from the environment, including offer amounts, cleared wholesale prices and quantities, retail energy prices and user selected desired operating levels corresponding to retail energy prices prior to the upcoming time interval.
3. Compute the offer amount by setting the offer amount using the output of the bidding policy function when the state collected from the environment are taken as the input. The biding policy function is represented by the bidding policy network which implemented as a neural network.
4. Compute the retail energy price by setting the price using the output of the pricing policy function when the state collected from the environment and the computed offer amounts are taken as the inputs. The pricing policy function is represented by the pricing policy network, wherein the pricing policy network is implemented as a neural network.

Computing a retail price refers to determining a retail price of electricity for operating the electrical device. By non-limiting example, the computing of a retail price found in Section headings of the Specification labeled “computing retail price”, however, some Sections may not be labeled. The computing a retail price is jointly implemented with computing an offer amount within the deep reinforcement learning process described in Algorithm 1, or the algorithm 2, according to different action synchronization mechanism is used between the wholesale market and the retail market. Detailed steps can be found in above paragraphs on computing an offer amount.

Clearing pricing for electricity by a local resource allocation market (LRAM), is a price cleared by an operator, which is the price used to assist in computing the retail price. The clearing pricing for electricity is determined along with a cleared quantity for electricity that is purchased from the wholesale electricity market and then resold in the retail electricity market. For example, electricity (both power and energy) is a commodity capable of being bought, sold, and traded. An electricity market is a system enabling purchases, through bids to buy; sales, through offers to sell; and short-term trades, generally in the form of financial or obligation swaps. Bids and offers use supply and demand principles to set the price. Wholesale transactions (bids and offers) in electricity are typically cleared and settled by the market operator or a special-purpose independent entity charged exclusively with that function. Market operators do not clear trades but often require knowledge of the trade in order to maintain generation and load balance. For example, market clearing can begin with the organizing of both buying and selling components. Wherein buyers can be organized from highest price to lowest price. Sellers can be organized from lowest price to highest price. Then, one approach may be that buyer and seller curves are created by an accumulating sum of the quantities associated with these organized prices. Wherein the curves can be implemented as computer-usable representations of the curves that are computed and stored once a necessary input data is received. The representations of the curves can include, groups of values or other data elements or structures. The two, sorted curves can then be overlaid or otherwise analyzed to determine an intersection between the curves. In general, the market clears at the intersection of the buying and selling curves of the market. The commodities within an electric market generally consist of two types: power and energy. Power is the metered net electrical transfer rate at any given moment and is measured in megawatts (MW). Energy is electricity that flows through a metered point for a given time interval and is measured in megawatt-hours (MWh). Markets for energy-related commodities trade net generation output for a number of intervals usually in increments of 5, 15 and 60 minutes.

Past clearing pricing for electricity by the LRAM are clearing pricing for electricity from a past time, i.e. historical clearing pricing for electricity in time.

Clearing pricing for electricity in the REM is the retail price cleared in the REM and the user is charged with this price for the actual energy consumption to operate the electrical device at desired operating levels.

Past clearing pricing for electricity in the REM are clearing pricing for electricity in the REM from a past time, i.e. historical clearing pricing for electricity in the REM in time.

Inter-temporal correlation behaviors of offer amounts to a local resource allocation market (LRAM) and cleared prices and quantities for electricity by the LRAM, refers to that there is a time-dependent relationship between offer amounts and cleared prices and quantities for electricity. For example, the cleared prices and quantities for electricity for a given time interval depend on not only the offer amount for the given time interval, but also the offer amounts and the cleared prices and quantities for electricity at previous time intervals to the given time interval.

Inter-temporal correlation behaviors of user selected desired operating levels by the user, pricing for electricity in the REM and the clearing pricing for electricity by the LRAM, refers to that there is a time-dependent relationship among user selected desired operating levels by the user, pricing for electricity in the REM and the clearing pricing for electricity by the LRAM. For example, the pricing for electricity in the REM for a given time interval is related to the clearing pricing for electricity by the LRAM at the given time interval, and user selected desired operating levels, the clearing pricing for electricity by the LRAM, and the pricing for electricity in the REM at previous time intervals.

Energy balance constraint, by non-limiting example, refers to the amount of electricity/energy purchased from the wholesale electricity market must be equal to the amount of electricity/energy sold to the retail electricity market, and any mismatches must be reduced by adjusting aggregate power consumption of EUCs, or charged with additional costs. The adjusting aggregate power consumption can be achieved through either adjusting the user operating levels of electrical devices, shifting the energy usage from one time-interval to another time-interval, adjusting charging and discharging statuses of storages own by the LSE, or adjusting operating levels of distributed energy resources own by the LSE.

Comparing the submitted offer amount to the retail price, by non-limiting example, can include determining if there is a difference between the submitted offer amount and the retail price. If yes, an adjustment on the user operating level is required to maximize the user's benefit based on the retail price.

Activate or deactivate the electrical device can be carried out based on the comparison results on the submitted offer amount to the retail price, to adjust actual user operating level. The activating and deactivating of the electrical device, can include activating the electrical device by supplying electricity or deactivating the electrical device by not supplying electricity, or activating/deactivating some components of the electrical device. The user desired operating level can be determined by using the dynamical demand response function with given retail price. For example, the user has an electrical device consisting of multiple electric heaters. This user can adjust the user operating level by switching on or off some heaters for matching the determined amount of electricity by the demand response function corresponding to the retail price.

### Embodiments

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non-transitory program carrier for execution by, or to control the operation of, data processing apparatus. Further still, program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A system to control operation of an electrical device in a market-based resource allocation system, the system having a processor configured, in as close to real-time, to receive, via a transceiver, a user selected desired operating level of an electrical device by a user for an upcoming time interval, the processor connected to a memory having executable programs and stored data, the system comprising:
use the processor to
compute, an offer amount representative of a value at which electricity is available to be supplied to operate the electrical device for the upcoming time interval at the user selected desired operating level, wherein computing the offer amount is based on multiple factors for the upcoming time interval, including the user selected desired operating level, current environmental data, and stored historical energy futures market data used to determine inter-temporal correlation behaviors of past offer amounts to a local resource allocation market (LRAM) and past clearing pricing for electricity by the LRAM, to obtain the offer amount;
transmit, via the transceiver, the offer amount to the LRAM;
receive, via the transceiver, a cleared price for electricity from the LRAM from which the electrical device receives electricity;
compute, a retail price of electricity for operating the electrical device based at least in part on the user selected desired operating level, and the current environmental data, the cleared price for electricity from the LRAM and the stored historical data from the energy futures market used to determine inter-temporal correlation behaviors of past user selected desired operating levels by the user, past pricing for electricity in a retail electricity market (REM) and the past clearing pricing for electricity by the LRAM, to obtain the retail price, wherein the computation of the offer amount and the retail price are computed jointly;
compare the submitted offer amount to the retail price; and
activate or deactivate the electrical device based on the comparison.

2. The system of claim 1, wherein the user selected desired operating level is selected from a first user desired operating level and a second user desired operating level, wherein the second user desired operating level is representative of the user choosing to pay more value to attain a desired operation level for the electrical device compared to the first desired operating level.

3. The system of claim 1, wherein the LRAM is a wholesale electricity market (WEM) operated by an independent system operator (ISO), and the user selected desired operating level of the user, is an end use customer (EUC) consumer of the electricity in the REM, wherein the offer amount and the retail price are utilized by a load serving entity (LSE).

4. The system of claim 1, wherein the LRAM is a real-time electricity market or a day-ahead electricity market.

5. The system of claim 1, wherein the electrical device is one of an air-conditioning unit, a heating unit, a hot water heater, a refrigerator, a dish washer, a washing machine, a dryer, an oven, a microwave oven, a pump, a home lighting system, an electric vehicle charger, one or more commercial electrical system or a home electrical system.

6. The system of claim 1, wherein the current environmental data includes environmental data for the user location, as well as forecasted environmental data for the user location for the upcoming time interval.

7. The system of claim 1, wherein the stored historical energy futures market data includes past energy futures market information and past LRAM information, and wherein the computing of the offer amount is performed based at least in part on offer amount information from the past energy futures market information, and at least in part on offer amount information from the past LRAM.

8. The system of claim 7, wherein the offer amount information from the electricity futures market information includes offer information from a fixed window of time from a real-time electricity market, and wherein the offer amount information from the LRAM information includes offer amount information for a rolling window of time.

9. The system of claim 1, wherein the offer amount and the retail price are utilized by a load serving entity (LSE), and computed jointly by maximizing LSE expectation of future profits starting from the upcoming time interval, subject to at least one energy balance constraint, and a future profit of the upcoming time interval determined based on a difference between the retail price and the cleared LRAM price, and an amount of electricity consumed by the user for the upcoming time interval and a cleared quantity of electricity corresponding with the cleared price for electricity from the LRAM.

10. The system of claim 9, wherein the amount of electricity consumed by the user is a dynamical demand response function of retail prices, and amounts of electricity consumed by the user at time intervals prior to the upcoming time interval, and the computed retail price for the upcoming time interval.

11. The system of claim 10, wherein, the dynamical demand response function is learned using a supervised learning approach by a multi-layer feedforward neural network when a finite number of previous time intervals are used, or a recurrent neural network (RNN) or a long short-term memory (LSTM) unit network, when all available previous time intervals are used.

12. The system of claim 9, the cleared price and the cleared quantity of electricity for electricity from the LRAM is a dynamical bid response function of the cleared prices and quantities for electricity by the LRAM at time intervals prior to the upcoming time interval, and the offer amount to the LRAM for the upcoming time interval.

13. The system of claim 12, wherein the dynamical bid response function is learned using a supervised learning approach by a multi-layer feedforward neural network, when a finite number of a previous time interval is used, or a recurrent neural network (RNN) or a long short-term memory (LSTM) unit network, when all available previous time intervals are used.

14. The system of claim 1, wherein the offer amount and the retail price of a load serving entity (LSE) is determined jointly, the retail price is first computed using a pricing policy based on previous state information, and the offer amount is then computed using a bidding policy based on previous state information, and the computed retail price; wherein the previous state information includes LSE offer amounts, LRAM cleared prices and quantities, amounts of electricity consumed by the user, and retail prices for all time intervals prior to the upcoming time interval.

15. The system of claim 1, wherein the offer amount and the retail price of a load serving entity (LSE) is determined jointly, the offer amount is computed using a bidding policy based on previous state information, and the retail price is computed using the pricing policy based on previous state information, the offer amount, and the cleared price and a cleared quantity of electricity from the LRAM; and wherein the previous state information includes an LSE offer amount, LRAM cleared prices and quantities, amounts of electricity consumed by the user, and retail prices for all time intervals prior to the upcoming time interval.

16. The system of claim 1, wherein the retail price of a load serving entity (LSE) is computed by a pricing policy based on current state information, where the state information includes past individualized user selected desired operating levels by the user at past corresponding time intervals to the upcoming time interval, and past individualized LSE retail pricing data for electricity in a retail electricity market (REM) at past corresponding time intervals to the upcoming time interval, and past cleared pricing data for electricity from the LRAM at past corresponding time intervals to the upcoming time interval.

17. The system of claim 1, wherein the computation of the offer amount and the retail price are computed jointly by formulating a Markov decision process, and solved using deep deterministic policy gradients approach with an actor-critic structure, wherein an actor is implemented by neural networks to determine a candidate of an offer amount and a retail price, and a critic is implemented by neural networks to evaluate a performance of the candidate offer amount and the candidate retail price, to adjust the parameters of neural networks, for improving performance.

18. The system of claim 17, wherein the actor includes a pricing policy network, a bidding policy network, and a pricing policy target network, and the critic includes a critic network, and a critic target network, wherein the pricing policy network is first used to compute a retail price, then the bidding policy network is used to compute an offer amount with the computed retail price to improve the overall profit earned by the LSE.

19. The system of claim 17, wherein the actor includes a pricing policy network, a bidding policy network, a pricing policy target network, and a bidding policy target network, and the critic includes a critic network, and a critic target network; wherein the bidding policy network is first used to compute an offer amount, then the pricing policy network is used to compute an retail price with the cleared prices and quantities from the LRAM corresponding to the computed off amount, to improve the overall profit earned by the LSE.

20. A system to control operation of an electrical device in a market-based resource allocation system, the system having a processor configured, in as close to real-time, to receive, via an input interface, a user selected desired operating level of an electrical device by a user for an upcoming time interval, the processor connected to a memory having executable programs and stored data, the system comprising:
use the processor to
compute, an offer amount representative of a value at which electricity is available to be supplied to operate the electrical device for the upcoming time interval at the user selected desired operating level;
transmit, via an output interface, the offer amount to a local resource allocation market (LRAM);
receive, via the input interface, a cleared price for electricity from the LRAM from which the electrical device receives electricity;
compute, a retail price of electricity for operating the electrical device based at least in part on the user selected desired operating level, and current environmental data, the cleared price for electricity from the LRAM and stored historical data from the energy futures market used to determine inter-temporal correlation behaviors of past user selected desired operating levels by the user, past pricing for electricity in a retail electricity market (REM) and past clearing pricing for electricity by the LRAM, to obtain the retail price, wherein the computation of the offer amount and the retail price are computed jointly;
compare the submitted offer amount to the retail price by a maximization of a user's benefit; and
activate or deactivate the electrical device based on the maximization of the user's benefit.

21. The system of claim 20, wherein computing the offer amount is based on multiple factors for the upcoming time interval, including the user selected desired operating level, the current environmental data, and the stored historical energy futures market data used to determine inter-temporal correlation behaviors of past offer amounts to a local resource allocation market (LRAM) and the past clearing pricing for electricity by the LRAM, to obtain the offer amount.

22. A method to control operation of an electrical device in a market-based resource allocation system, the method having a processor configured, in as close to real-time, to receive, via an input interface, a user selected desired operating level of an electrical device by a user for an upcoming time interval, the processor connected to a memory having executable programs and stored data, the method comprising:
using the processor for
computing, an offer amount representative of a value at which electricity is available to be supplied to operate the electrical device for the upcoming time interval at the user selected desired operating level;
transmitting, via an output interface, the offer amount to a local resource allocation market (LRAM);
receiving, via the input interface, a cleared price for electricity from the LRAM from which the electrical device receives electricity;
computing, a retail price of electricity for operating the electrical device based at least in part on the user selected desired operating level, and current environmental data, the cleared price for electricity from the LRAM and stored historical data from the energy futures market used to determine inter-temporal correlation behaviors of past user selected desired operating levels by the user, past pricing for electricity in a retail electricity market (REM) and past clearing pricing for electricity by the LRAM, to obtain the retail price, wherein the computation of the offer amount and the retail price are computed jointly;
comparing the submitted offer amount to the retail price; and
activating or deactivating the electrical device based on the comparison.

23. The method of claim 22, wherein computing the offer amount is based on multiple factors for the upcoming time interval, including the user selected desired operating level, the current environmental data, and the stored historical energy futures market data used to determine inter-temporal correlation behaviors of past offer amounts to a local resource allocation market (LRAM) and the past clearing pricing for electricity by the LRAM, to obtain the offer amount.
